(19) United States
(12) Patent Application Publication
(10) Pub. No.: US 2003/0126008 A1
(43) Pub. Date: Jul. 3, 2003

(54) Provider-led discounting method for merchandise/service

(75) Inventor: Masahiko Okuyama, Sendai (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 10/106,310

(22) Filed: Mar. 26, 2002

(30) Foreign Application Priority Data
Dec. 28, 2001 (JP) 2001-401273

(51) Int. Cl. G06F 17/60

(52) U.S. Cl. 705/10

(57) ABSTRACT

When a purchaser purchases target merchandise/service or contending merchandise/service, discount information can be determined depending on the current share of the target merchandise/service by referring to a condition table in which a discount condition is entered depending on the share of the merchandise/service.

### BACKGROUND OF THE INVENTION

1. Field of the Invention

The present invention relates to an information process relating to the sales of merchandise or services, and more specifically to a provider-led discounting method for merchandise or services.

2. Description of the Related Art

The operations relating to merchandise or services are listed below.

Operations and management of committing sales of merchandise at a discount to retailers with a view to improving the market share of the merchandise/service (manufacturers, dealers)

Operations and management of selling merchandise at a discount when selling merchandise/service (retailers).

Conventionally, when a manufacturer or a dealer sells merchandise with a view to improving the market share of its own merchandise, it mounts a sales campaign in advance, and requests a seller (mass merchandiser, etc.) to set a discount regardless of the sales volume or the fluctuation in share. In this case, the discount rate is fixed in a predetermined period.

Since a manufacturer or a dealer cannot obtain the information about the sales scene of its own merchandise and contenders, it is difficult for the manufacturer or the dealer to confirm the current market share of its own merchandise in real time.

In this discount method, there is the problem that the discount rate has to be fixed in a predetermined period although the sales volume has increased (the market share has increased) by the effect of the sales campaign and the sales at a discount. There also is the problem that preparatory tasks are required to mount a sales campaign or sell merchandise at a discount.

### SUMMARY OF THE INVENTION

An object of the present invention is to provide a discounting method to efficiently improve the market share using the information process on the sales of merchandise/service.

In the first discounting method according to the present invention, when a purchaser purchases merchandise or a service, the computer refers to the condition table in which the discount condition is associated with the market share of merchandise/service. Based on the condition table, the discount information is determined depending on the current share of the merchandise/service, and the determined discount information is given to the seller.

As the discount information, for example, one of the information indicating the sales of merchandise/service at a discount and the information indicating an issue of a coupon available when merchandise/service is purchased is used.

In the above mentioned discounting method, the discount information about the merchandise/service to be discounted is determined depending on the market share of the merchandise/service when it is sold, and the information is automatically given to the seller. According to the received information, the seller offers the discount to purchasers. Since the discount promotes the sales of the merchandise/service, the market share of the merchandise/service can be efficiently improved by setting the discount condition depending on the market share.

Additionally, in the second discounting method, when a purchaser purchases a contending merchandise corresponding to target merchandise or a contending service corresponding to a target service, the computer refers to the condition table in which the discount condition is associated with the combination of the market share of the target merchandise and the contending merchandise or the combination of the market share of the target service and the contending service. Based on the condition table, the discount information can be determined about the target merchandise or the target service depending on the current market share of the target merchandise or the target service, and the seller is notified of the determined discount information.

The target merchandise/service refers to the merchandise/service to be discounted, and the target contending merchandise/service refers to the contending merchandise/service which is contending with the target merchandise/service.

In the above mentioned discounting methods, when a purchaser purchases contending merchandise/service, the discount information about the target merchandise/service is determined depending on the current market share of the target merchandise/service, and is automatically transmitted to the seller. The seller offers the discount on the target merchandise/service indicated by the received information to the purchaser of the contending merchandise/service.

Since the sales of the target merchandise/service can be promoted by the discount, the market share of the target merchandise/service can be efficiently improved against specified contending merchandise/service.

In the third discounting method according to the present invention, when a purchaser purchases contending merchandise against the target merchandise or a contending service against the target service, the computer refers to the condition table in which the discount condition is associated with the combination of the market share of the target merchandise and the market share of the contending merchandise or the combination of the market share of the target service and the market share of the contending service. Based on the condition table, the discount information can be determined about the target merchandise or the target service depending on the current market shares of the target merchandise and the contending merchandise or the market shares of the target service and the contending service, and the seller is notified of the determined discount information.

In the above mentioned discounting method, when a purchaser purchases contending merchandise/service, the discount information about the target merchandise/service is determined depending on the current market shares of both target merchandise/service and contending merchandise/service, and the seller is automatically notified of the information. The seller offers the discount indicated by the received information about the target merchandise/service to a purchaser of the contending merchandise/service.

Therefore, as in the second discounting method, the market share of the target merchandise/service can be efficiently improved against specified contending merchandise/service.

### BRIEF DESCRIPTION OF THE DRAWINGS

FIG. 1 shows a discounting method;

FIG. 2 shows a practical example of a discount;

FIG. 3 shows the configuration of a discounting system;

FIG. 4 shows a discounting process;

FIG. 5 shows table information;

FIG. 6 shows a first condition table;

FIG. 7 shows a second condition table;

FIG. 8 shows a third condition table;

FIG. 9 shows a first merchandise share table;

FIG. 10 shows the first example of a discounting process;

FIG. 11 is a flowchart of the first discounting process;

FIG. 12 shows a fourth condition table;

FIG. 13 shows a second merchandise share table;

FIG. 14 shows a third merchandise share table;

FIG. 15 shows a fifth condition table;

FIG. 16 shows a fourth merchandise share table;

FIG. 17 shows a sixth condition table;

FIG. 18 shows a seventh condition table;

FIG. 19 shows first share fluctuation data;

FIG. 20 shows a first share fluctuation graph;

FIG. 21 shows the second example of the discounting process;

FIG. 22 is a flowchart of the second discounting process;

FIG. 23 shows an eighth condition table;

FIG. 24 shows a ninth condition table;

FIG. 25 shows a tenth condition table;

FIG. 26 shows an eleventh condition table;

FIG. 27 shows a fifth merchandise share table;

FIG. 28 shows a twelfth condition table;

FIG. 29 shows the third example of a discounting process;

FIG. 30 is a flowchart of the third discounting process;

FIG. 31 shows a thirteenth condition table;

FIG. 32 shows a fourteenth condition table;

FIG. 33 shows a fifteenth condition table;

FIG. 34 shows a sixteenth condition table;

FIG. 35 shows a seventeenth condition table;

FIG. 36 shows second share fluctuation data;

FIG. 37 shows a second share fluctuation graph;

FIG. 38 shows the configuration of an information processing device; and

FIG. 39 shows a storage medium.

### DESCRIPTION OF THE PREFERRED EMBODIMENTS

The embodiments of the present invention are described below by referring to the attached drawings.

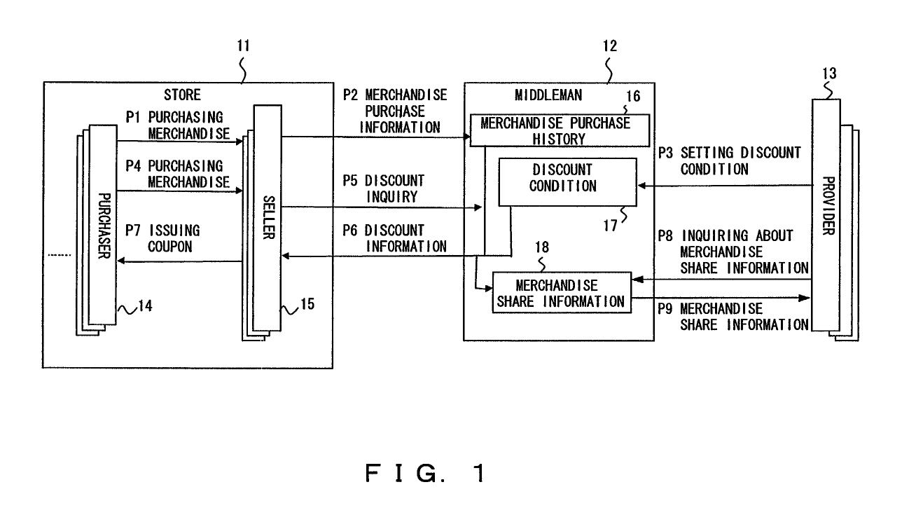

FIG. 1 shows the outline of the discounting method according to an embodiment of the present invention. A seller 15 of a store 11 corresponds to a mass-merchandiser, etc. and sells plural pieces of merchandise to purchasers (consumers) 14. A provider 13 corresponds to a manufacturer/dealer, etc., and provides merchandise for the store 11. An middleman 12 determines the discounting process for merchandise, and offers the discount information to the seller 15.

A discount includes a reduction both in amount and rate. A discount in amount is offered by reducing a predetermined amount from the price of merchandise, and a discount in rate is offered by reducing from the price of merchandise the amount computed by subtracting a predetermined rate of price. It is assumed that there are one or more the purchasers 14, sellers 15, and providers 13.

In the store 11, when the purchaser 14 purchases merchandise (P1), merchandise purchase information is transmitted from the seller 15 to the middleman 12 (P2). At this point in time, a discount condition 17 is not set. Therefore, the middleman 12 accumulates the received merchandise purchase information in a merchandise purchase history 16, computes the current market share (sales ratio of each article to a contending merchandise) of the target merchandise/contending merchandise, and manages the result as merchandise share information 18.

Then, the provider 13 sets the discount condition corresponding to the share of target merchandise/contending merchandise, and transmits the result to the middleman 12 (P3). The middleman 12 manages the received condition as the discount condition 17. As the discount condition 17, the discount amount or the discount rate is set depending on the share of target merchandise/contending merchandise, and simultaneously either sales at a discount or an issue of a coupon is set.

Then, when the purchaser 14 purchases merchandise (P4), the seller 15 asks the middleman 12 about a discount (P5). The middleman 12 determines the discounting process by referring to the merchandise purchase history 16 and the discount condition 17, and transmits the relevant discount information to the seller 15 (P6). The middleman 12 updates the merchandise share information 18.

The seller 15 presents the received discount information to the purchaser 14 (P7). At this time, if the discount information indicates a sale at a discount, then the merchandise is sold at a discount. If it indicates an issue of a coupon, a coupon is issued. The issued coupon can be used when the next target merchandise is purchased.

When the provider 13 asks the middleman 12 about the merchandise share information (P8), the middleman 12 notifies the provider 13 of the current share of the target merchandise/contending merchandise recorded in the merchandise share information 18 (P9).

In the above mentioned discounting method, the provider 13 sets the discount condition in advance depending on the share of the merchandise, thereby automatically determining the discounting process depending on the market share recorded when the merchandise is purchased. Therefore, the seller 15 can constantly present appropriate discount information to the purchaser 14. Furthermore, since the provider 13 can obtain the share of target merchandise and contending merchandise in real time, an effective merchandising policy can be prepared.

Additionally, both provider 13 and seller 15 can obtain a sales promotion effect, and the purchaser 14 can receive an incentive of a discount when the purchaser 14 purchases desired merchandise at any seller 15. For example, if the discount condition is set such that the lower the share of target merchandise (the higher the share of contending merchandise), the deeper discount of the target merchandise, then the target merchandise can be improved in share.

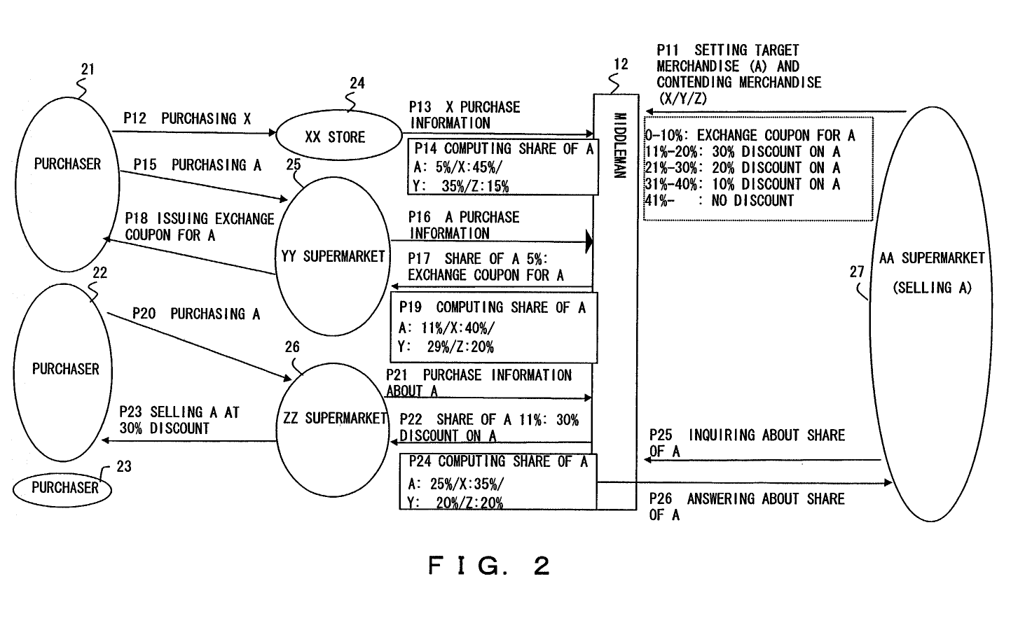

FIG. 2 shows a practical example of the above mentioned discounting method. In FIG. 2, an AA supermarket 27 is a provider of merchandise A, and an XX store 24, a YY supermarket 25, and a ZZ supermarket 26 are sellers of the merchandise A.

First, the AA supermarket 27 sets the contending merchandise X, Y, and Z against the target merchandise A, and the discount condition depending on the share of the merchandise A, and transmits the result to the middleman 12 (P11). In this case, the following discount condition is set.

| Share of | |
|---|---|
| merchandise A | Discounting process |
| 0-10% | issuing a merchandise A exchange coupon |
| 11-20% | selling merchandise A at 30-percent |
| | discount |
| 21-30% | selling merchandise A at 20-percent |
| | discount |
| 31-40% | selling merchandise A at 10-percent |
| | discount |
| 41%- | no discount |

Next, when a purchaser 21 purchases contending merchandise X from the XX store 24 (P12), the XX store 24 transmits the purchase information about the merchandise X to the middleman 12 (P13). In this case, since the merchandise X is not to be discounted, the middleman 12 computes the current merchandise share (P14). As a result, the shares of the merchandise A, X, Y, and Z are 5%, 45%, 35%, and 15% respectively.

When the purchaser 21 purchases the target merchandise A from the YY supermarket 25 (P15), the supermarket 25 transmits the purchase information about the merchandise A to the middleman 12 (P16). The middleman 12 determines the discounting process depending on the share of the merchandise A by referring to the discount condition received from the AA supermarket 27, and notifies the YY supermarket 25 of the determination result (P17).

In this case, since the share of the merchandise A is 5%, the discount information about ‘issuing a merchandise A exchange coupon’ is transmitted to the YY supermarket 25. The YY supermarket 25 issues a merchandise A exchange coupon to the purchaser 21 (P18). The purchaser 21 can obtain a free piece of merchandise A using the coupon.

The middleman 12 computes the current share of the merchandise, and updates the merchandise share information (P19). As a result, the shares of the merchandise A, X, Y, and Z are 11%, 40%, 29%, and 20% respectively.

When another purchaser 22 purchases the target merchandise A from the ZZ supermarket 26 (P20), the zz supermarket 26 transmits the purchase information about the merchandise A to the middleman 12 (P21). The middleman 12 refers to the discount condition, determines the discounting process depending on the share of the merchandise A, and notifies the ZZ supermarket 26 of the determination result (P22).

Since the share of the merchandise A is 11%, the discount information about ‘selling the merchandise A at a discount of 30%’ is transmitted to the ZZ supermarket 26. Then, the ZZ supermarket 26 sells the merchandise A at a discount of 30% (P23).

The middleman 12 computes the current share of the merchandise, and updates the merchandise share information (P24). As a result, the shares of the merchandise A, X, Y, and Z are respectively 25%, 35%, 20%, and 20%.

A discount is similarly allowed when another purchaser 23 purchases the merchandise A. If the AA supermarket 27 inquires of the middleman 12 about the share of the merchandise A (P25), then the middleman 12 notifies the AA supermarket 27 of the current shares of the merchandise A, X, Y, and Z as a reply (P26).

On the above mentioned discount condition, the provider can improve the share using a free exchange coupon when the share of the merchandise A is considerably low, and can improve the share by allowing a high discount rate when the share is relatively low. When the share is relatively high, a low discount rate can be set. When the share is sufficiently high, no discount is allowed. Therefore, depending on the fluctuation of the share of the target merchandise A, an appropriate discount can be offered.

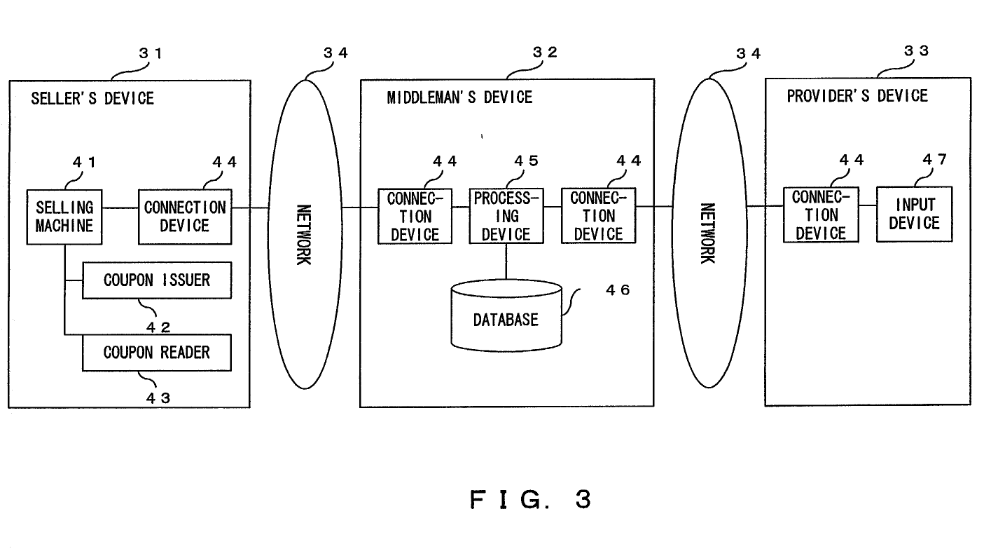

The information processing system (discounting system) for realizing the discounting method shown in FIG. 1 is described below by referring to FIGS. 3 through 9.

FIG. 3 shows the configuration of the above mentioned discounting system. The discounting system shown in FIG. 3 comprises a seller's device 31, a middleman's device (intermediate server) 32, and a provider's device 33. These devices are connected through a network 34 of Internet, etc.

The seller's device 31 comprises a selling machine 41, a coupon issuer 42, a coupon reader 43, and a connection device 44. The selling machine 41 contains a POS (point of sale) system and a register. The coupon issuer 42 issues a coupon to a purchaser. The coupon reader 43 reads the information about the coupon presented by the purchaser. The connection device 44 communicates with the middleman's device 32 through the network 34.

The middleman's device 32 comprises the connection device 44, a processing device 45, and a database 46. The database 46 stores a merchandise purchase history, a discount condition, merchandise share information, etc. The processing device 45 performs a necessary process by accessing the database 46. The connection device 44 communicates with the seller's device 31 or the provider's device 33 through the network 34.

The provider's device 33 provides the connection device 44 and an input device 47. The provider 13 inputs target merchandise, contending merchandise, a discount condition, etc. through the input device 47, and the connection device 44 communicates with the middleman's device 32 through the network 34.

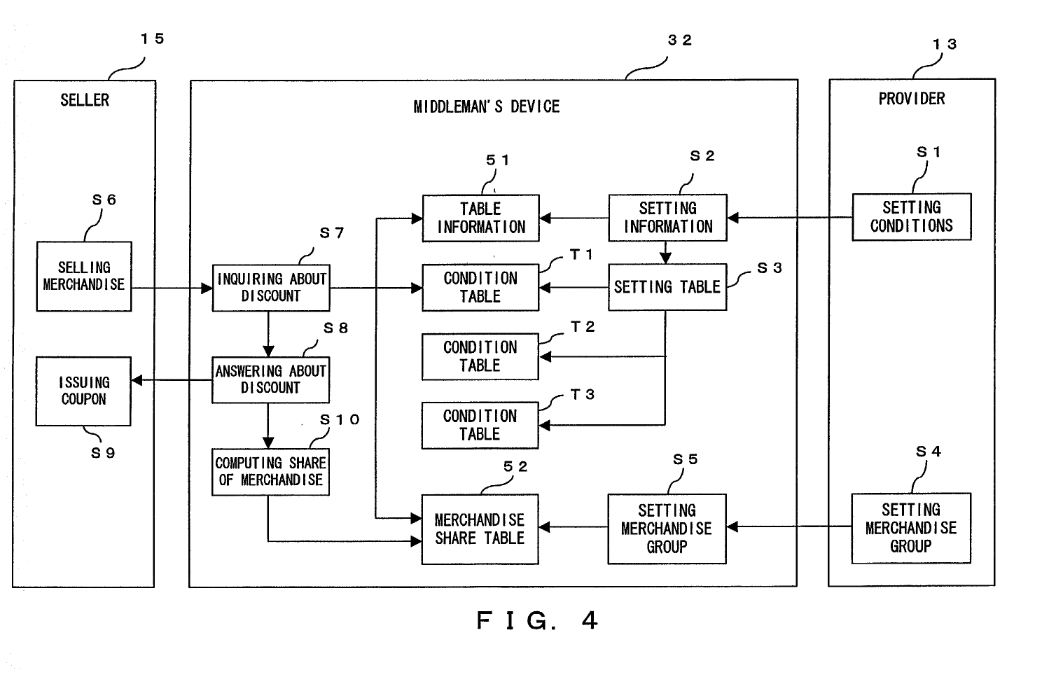

FIG. 4 shows the outline of the discounting process performed by the discounting system shown in FIG. 3. Table information 51, the condition tables T1, T2, and T3, and a merchandise share table 52 shown in FIG. 4 are stored in the database 46 shown in FIG. 3.

The correspondence between a merchandise group and a condition table is entered in the table information 51. The merchandise group includes target merchandise to be discounted and contending merchandise which is contending with the target merchandise, and the merchandise share is computed based on the merchandise. The condition tables T1, T2, and T3 include different discount conditions, and a merchandise share table 55 includes the market share of each article of merchandise for each merchandise group.

First, the provider 13 inputs a discount condition into the provider's device 33, and transmits it to the middleman's device 32 through the network 34 (step S1). The middleman's device 32 enters the received discount condition in the condition tables T1, T2, and T3. At this time, the identification information about the condition table corresponding to a merchandise group is set in the table information 51 (step S2), and the discount condition is set in the corresponding condition table (step S3).

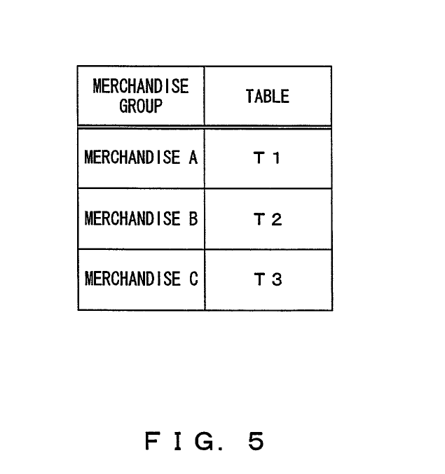

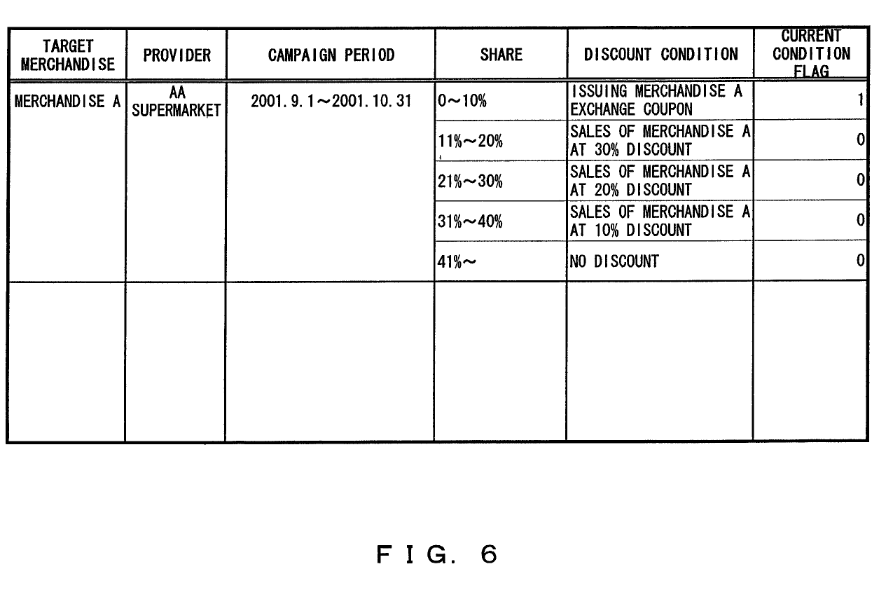

FIG. 5 shows an example of the table information 51. In this example, a merchandise A group, a merchandise B group, and a merchandise C group correspond to the condition tables T1, T2, and T3 respectively. FIGS. 6, 7, and 8 show examples of the condition tables T1, T2, and T3 respectively.

In the condition table T1 shown in FIG. 6, target merchandise refers to merchandise of a manufacturer to be discounted, and a provider refers to a provider of target merchandise. A campaign period refers to a period in which a campaign of target merchandise is carried out on an entered discount condition. A share refers to a market share of target merchandise, and a discount condition refers to a discounting process depending on the share of the target merchandise. A current condition flag indicates a currently applied discount condition.

In this example, the discount condition shown in FIG. 2 is entered for the merchandise A as target merchandise. The current condition flag indicating a ‘merchandise A exchange coupon’is set ON (logic of ‘1’), and other current condition flags are set OFF (logic of ‘0’). In this case, the current share of the merchandise A is 0˜10%, and a merchandise A exchange coupon is issued to a purchaser of the merchandise A.

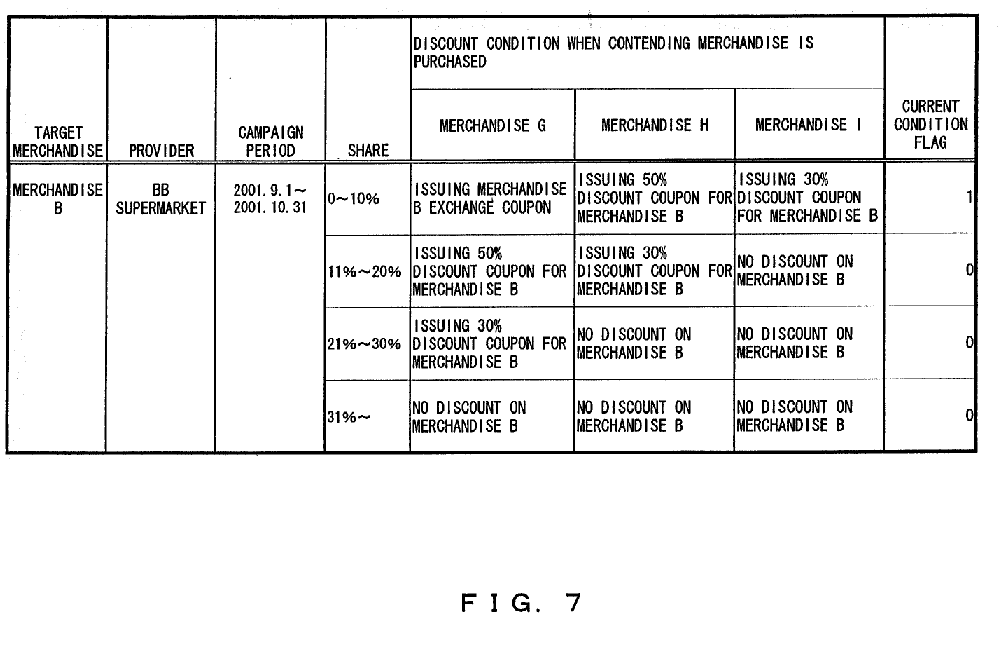

In the condition table T2 shown in FIG. 7, the discount condition applied when contending merchandise is purchased indicates the discounting process on the target merchandise offered depending on the combination of the share of the target merchandise and the purchased contending merchandise when a purchaser purchases the contending merchandise against the target merchandise (of the manufacturer).

In this example, the discount condition for the merchandise B is entered when target merchandise is the merchandise B, and contending merchandise is the merchandise G, H, and I. The current condition flag corresponding to the share of 0˜10% of the merchandise B is set ON. In this case, a merchandise B exchange coupon is issued to a purchaser of the merchandise G, a 50-percent discount coupon for merchandise B is issued to a purchaser of the merchandise H, and a 30-percent discount coupon for merchandise B is issued to a purchaser of the merchandise I.

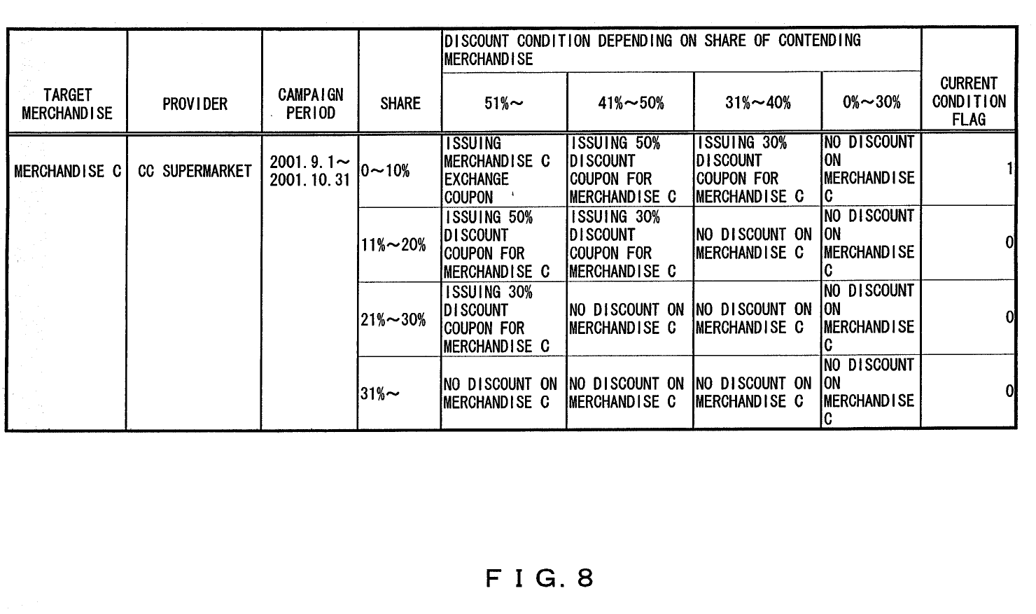

The discount condition corresponding the share of contending merchandise in the condition table T3 shown in FIG. 8 indicates the discounting process on the target merchandise offered depending on the combination of the share of the target merchandise and the share of the purchased contending merchandise when a purchaser purchases the contending merchandise against the target merchandise.

In this example, the discount condition on the merchandise C as target merchandise is entered, and the current condition flag corresponding to the share of 0˜10% of the merchandise C is set ON. In this case, a merchandise C exchange coupon is issued to a purchaser of contending merchandise having a share over 51%, and a 50-percent discount coupon for merchandise C is issued to a purchaser of the contending merchandise having a share of 41˜50%. A 30-percent discount coupon for merchandise C is issued to a purchaser of the contending merchandise having a share of 31˜40%, and no discount for the merchandise C is offered to a purchaser of the contending merchandise having a share of 0˜30%.

The provider 13 inputs the identification information (the name of merchandise, a merchandise code, etc.) about the merchandise belonging to each merchandise group, and transmits it to the middleman's device 32 through the network 34 (step S4). The middleman's device 32 sets the received information in the merchandise share table 52 (step S5).

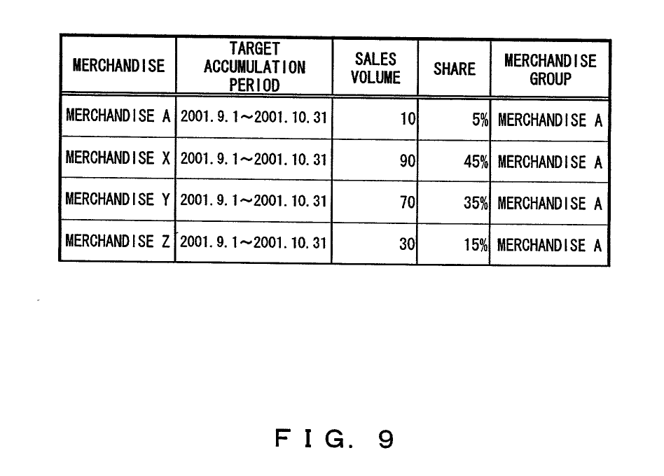

FIG. 9 shows an example of the merchandise share table 52. In FIG. 9, the merchandise refers to the identification information about merchandise, and the target accumulation period refers to the period in which the purchase history of each article of merchandise is accumulated (target share computation period). The sales volume and the share refer to the sales volume and the market share of each article of merchandise, and the merchandise group refers to the identification information about a merchandise group.

In this example, the target merchandise A and the contending merchandise X, Y, and Z are entered as the merchandise belonging to the merchandise A group, and the sum of their shares is 100%. The identification information about the target merchandise A is entered as the identification information about a merchandise group.

Similarly, the target merchandise B and the contending merchandise G, H, and I are entered as the merchandise B group, and the target merchandise c and the contending merchandise L, M, and N are entered as the merchandise C group.

When a purchaser purchases the merchandise A (step S6), the seller 15 inquires of the middleman's device 32 about the discounting process through the seller's device 31 (step S7), and the middleman's device 32 refers to the condition table corresponding to the merchandise A, and answers to the seller 15 about the discounting process (step S8).

In this case, according to the merchandise share table 52 shown in FIG. 9, the merchandise A belongs to the merchandise A group. According to the table information 51 shown in FIG. 5, the merchandise A group corresponds to the condition table T1. As a result, the condition table T1 shown in FIG. 6 is referred to. Then, a merchandise A exchange coupon corresponding to the current condition flag is transmitted to the seller's device 31 as an answer. The seller 15 issues a merchandise A exchange coupon through the seller's device 31 (step S9).

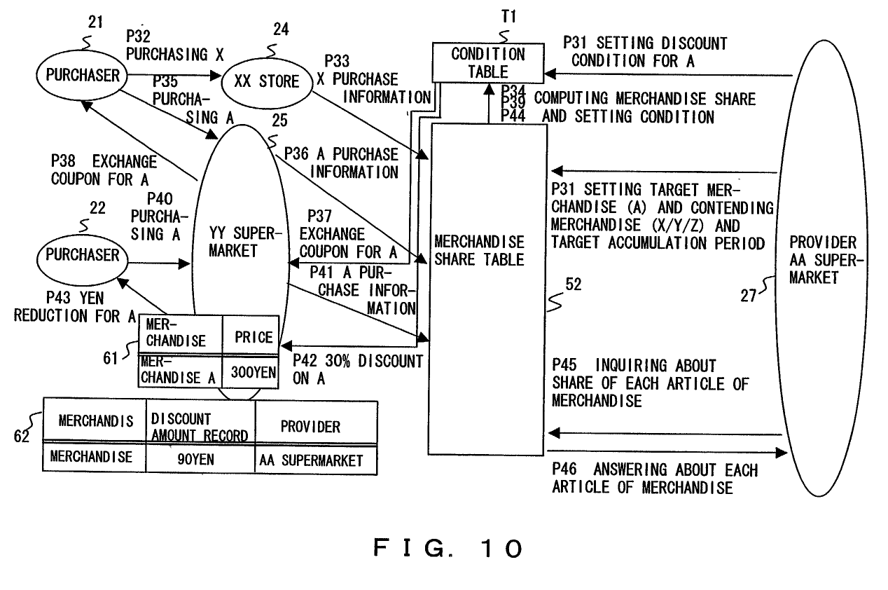

Then, the middleman's device 32 computes the current share of each article of merchandise, and updates the merchandise share table 52 (step S10). When the discount condition is changed by the update of the share, the current condition flag of the corresponding condition table is changed such that it indicates a new discount condition. The discounting process shown in FIG. 4 is described below in more detail by referring to FIGS. 10 through 36.

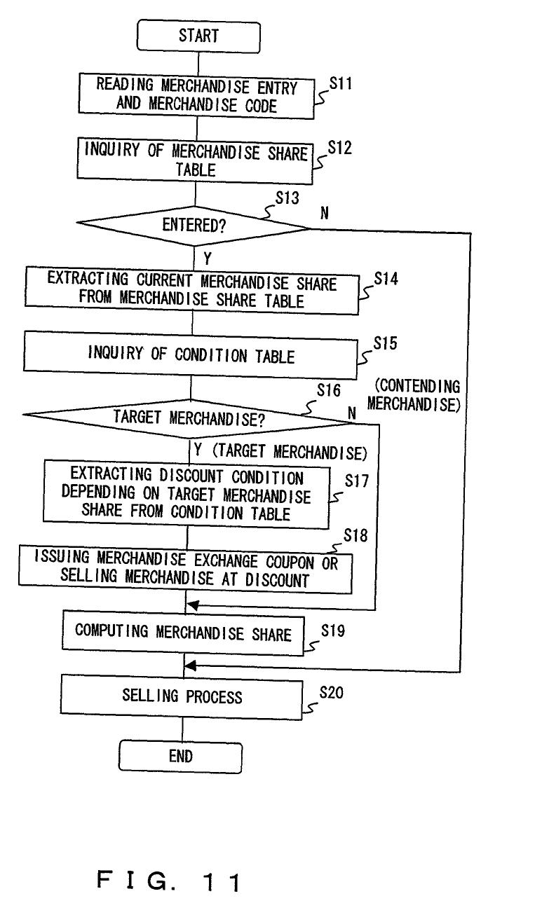

FIG. 10 shows the discounting process based on the condition table T1 shown in FIG. 4, and FIG. 11 is a flowchart of the discounting process.

In this process, the AA supermarket 27 sets a plurality of discounting processes on the merchandise A depending on the share of the target merchandise A. When a purchaser purchases the merchandise, the seller issues an inquiry to the middleman through the network. If the purchased merchandise is the merchandise A to be discounted, then the purchaser is automatically allowed a sales at a discount or receives a coupon depending on the share of the merchandise A when the merchandise is sold.

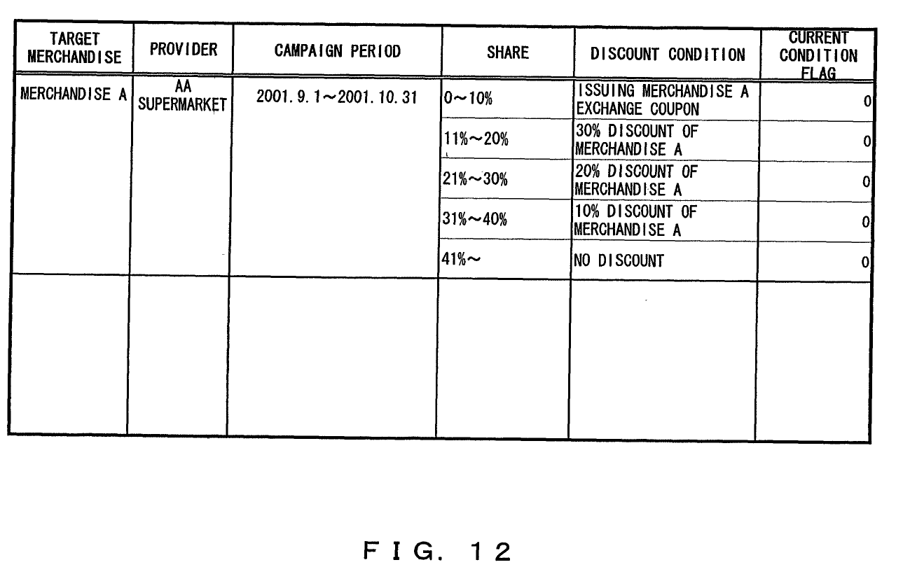

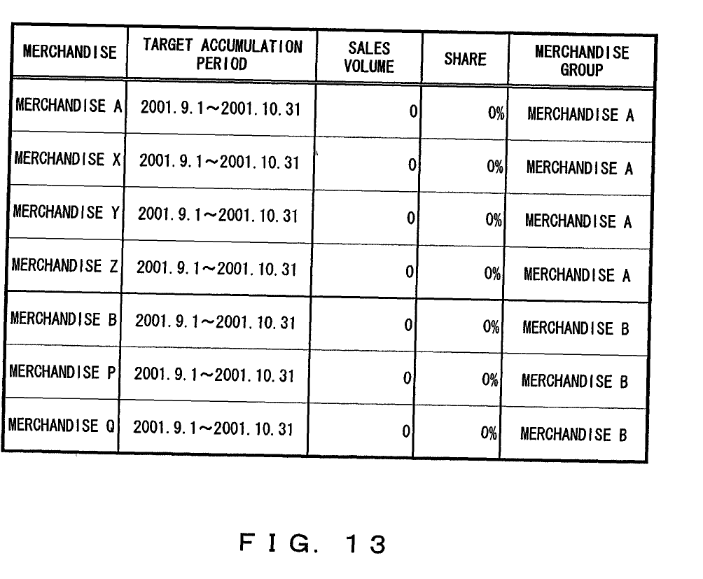

First, the AA supermarket 27 enters the discount condition depending on the share of the target merchandise A in the condition table T1 through the provider's device, and enters the merchandise A group (the target merchandise A, and the contending merchandise X, Y, and Z) and the target accumulation period in the merchandise share table 52 (step S11 on P31). In this example, the information as shown in FIG. 12 is entered in the condition table T1, and the information as shown in FIG. 13 is entered in the merchandise share table 52.

The merchandise A group (the merchandise A, X, Y, and Z) and the merchandise B group (the merchandise B, P, Q) are entered in the merchandise share table 52 shown in FIG. 13. However, since the merchandise purchase information has not been input yet, the sales volume and the market share are set to the initial value of 1, and all current condition flags in the condition table T1 shown in FIG. 12 are set OFF.

Next, when the purchaser 21 purchases the merchandise X from the XX store 24, the seller's device of the XX store 24 reads the merchandise code of the merchandise X (step S11, P32), and transmits the purchase information including the merchandise code to the middleman's device (P33). The middleman's device refers to the merchandise share table 52 according to the purchase information (step S12), and checks whether or not the merchandise X has been entered (belongs to any merchandise group) (step S13). In this example, the merchandise share table 52 is referred to, and it proves that the merchandise X has been entered in the merchandise A group.

Then, the middleman's device computes the current sales volume and share of each article of merchandise, sets the results in the merchandise share table 52, and sets a flag indicating the discount condition depending on the computed share in the condition table T1 (P34, step S19). As a result, the information about the merchandise A group in the merchandise share table 52 is changed as shown in FIG. 9, and the condition table T1 is changed as shown in FIG. 6. Then, the seller's device of the XX store 24 performs the selling process on the merchandise X (step S20).

When the purchaser 21 purchases the merchandise A from the YY supermarket 25, the seller's device of the YY supermarket 25 reads the merchandise code of the merchandise A (P35, step S11), and transmits the purchase information to the middleman's device (P36). The middleman's device refers to the merchandise share table 52 (step S12), and checks whether or not the merchandise A has been entered (step S13). As a result, it proves that the merchandise A has been entered in the merchandise A group.

Then, the middleman's device refers to the condition table T1 (step S15), and checks whether or not the merchandise A is target merchandise (step S16). As a result, it proves that the merchandise A is target merchandise.

Then, the middleman's device refers to the discount condition in which the current condition flag is set ON, determined the discounting process depending on the share of the merchandise A, and notifies the YY supermarket 25 of the determination result (P37, step S17). Since the flag of ‘issuing a merchandise A exchange coupon’ is set ON in the condition table T1 shown in FIG. 6, the YY supermarket 25 is notified of the discounting process.

The seller's device of the YY supermarket 25 issues a merchandise A exchange coupon to the purchaser 21 (P38, step S18), and performs the selling process on the merchandise A (step S20). In this case, a price table 61 is referred to and the merchandise A is sold at a predetermined price (300 yen).

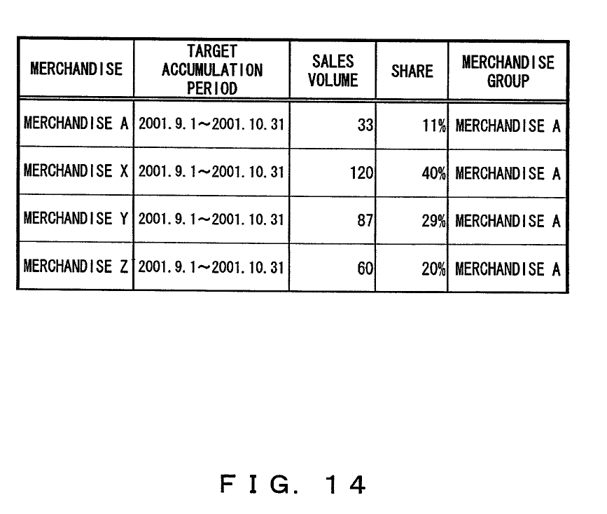

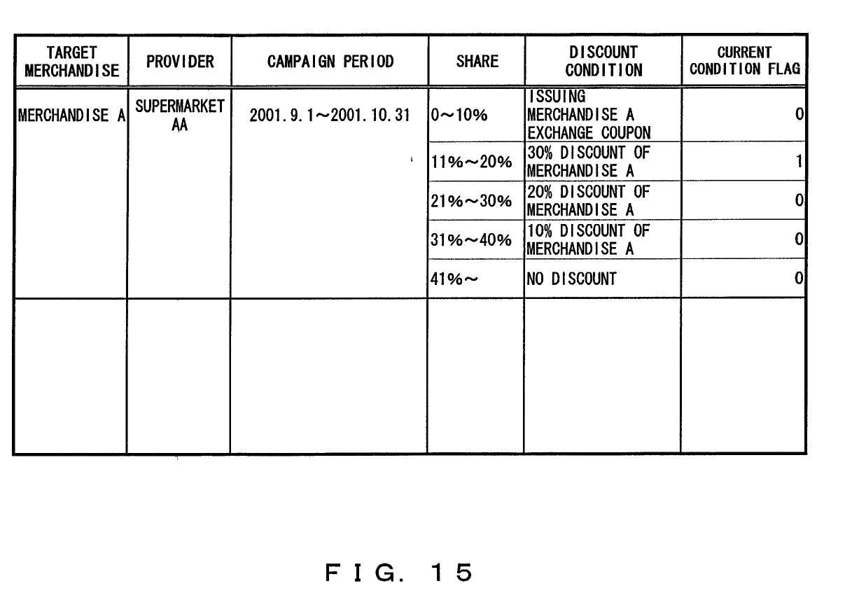

The middleman's device further updates the merchandise share table 52 and the condition table T1 (P39, step S19). As a result, the merchandise share table 52 is changed as shown in FIG. 14, an the condition table T1 is changed as shown in FIG. 15.

In this example, the current condition flag in the condition table T1 is referred to, and a discounting process is determined. However, the share in the merchandise share table 52 can be changed. In this case, upon receipt of the purchase information about the merchandise A (P36), the middleman's device extracts the current share of the merchandise A from the merchandise share table 52 (step S14). Then, the discount condition corresponding to the value is obtained from the condition table T1 (step S15).

When another purchaser 22 purchases the merchandise A from the YY supermarket 25 (P40), the purchase information about the merchandise A is transmitted from the seller's device of the YY supermarket 25 to the middleman's device (P41). The middleman's device determines the discounting process by referring to the merchandise share table 52 and the condition table T1, and notifies the YY supermarket 25 of the determination result (P42). According to the condition table T1 shown in FIG. 15, since the flag indicating a ‘30-percent discount on merchandise A’ is set ON, the YY supermarket 25 is notified of the discounting process.

Then, the YY supermarket 25 sells the merchandise A at a discount of 30% to the purchaser 22 (P43, step S18). In this case, the seller's device of the YY supermarket 25 computes the actual price (210 yen) of the merchandise A by subtracting the amount corresponding to the 30% discount from the price (300 yen) of the merchandise A entered in the price table 61. Then, the discount amount is entered in a discount record table 62. The discount record table 62 is used for management of the discount record of target merchandise.

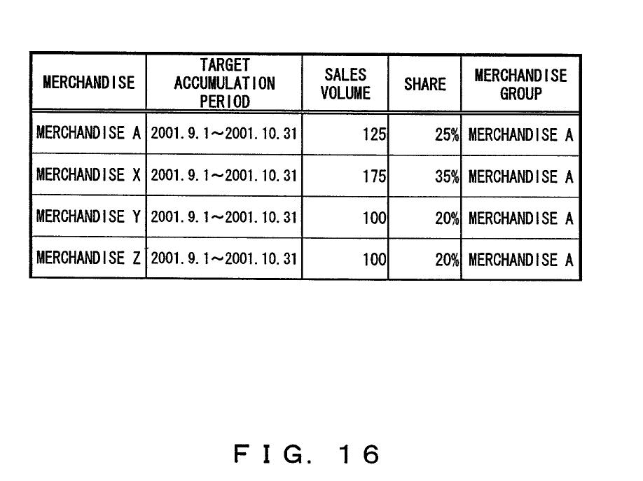

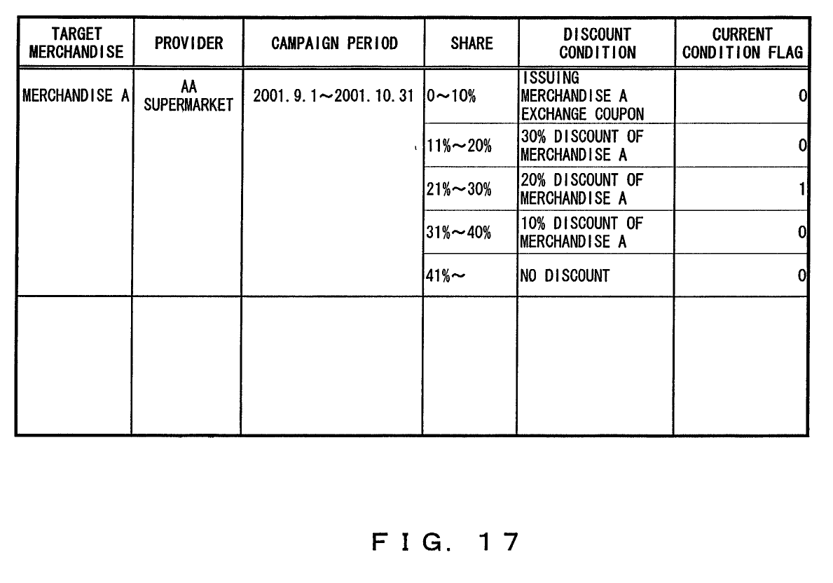

The middleman's device updates the merchandise share table 52 and the condition table T1 (P39). As a result, the merchandise share table 52 is changed as shown in FIG. 16, and the condition table T1 is changed as shown in FIG. 17.

If the AA supermarket 27 inquires of the middleman's device through the provider's device about the share of each article of merchandise (P45), then the middleman's device notifies the provider's device of the shares of the merchandise A, X, Y, and Z entered in the merchandise share table 52 as a reply (P46)

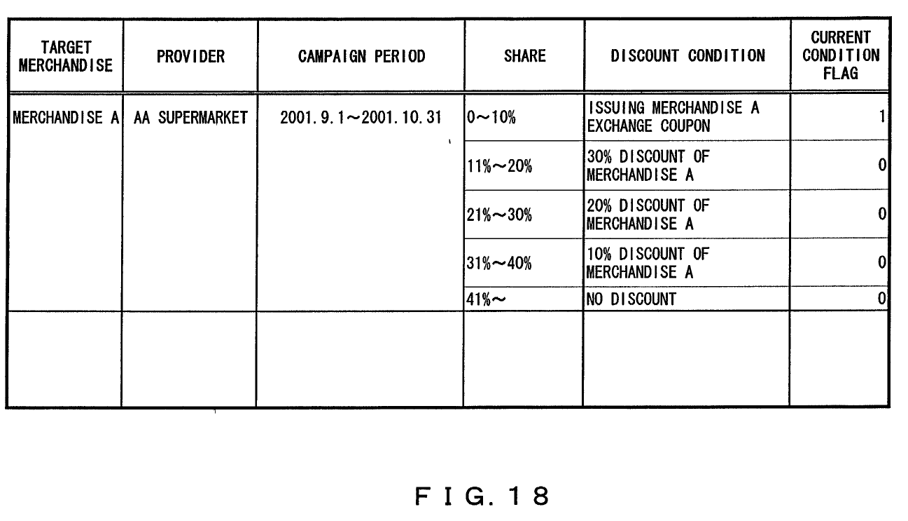

In the discounting process shown in FIG. 10, although an exchange coupon is issued and merchandise is sold at a discount, it is also possible to issue a discount coupon instead of the sales at discount. In this case, as shown in FIG. 18, the issue of an exchange coupon and a discount coupon is set as the discounting process for the merchandise A in the condition table T1. A purchaser who receives a discount coupon can purchase another piece of merchandise A at a predetermined discount rate.

In the above mentioned discounting process, the following effect can be expected.

(1) The preparatory survey for a sales campaign plan and a period and process steps required to make a prediction can be reduced.

(2) A campaign can be started earlier, and a possible sales loss due to the delay of a sales campaign can be avoided.

(3) The campaign cycle (execution→effect/checking influence→evaluation→next plan) can be shortened with the labor saved. In addition, the period and process steps can be utilized for sales promotion planning other than the discounting process.

(4) To attain a target share, a dynamic discount strategy associated with the share fluctuation can be adopted.

(5) Since the management of a discount condition depending on the merchandise share can be committed to a middleman in advance, the load on a seller and provider can be reduced.

(6) Since a provider can grasp the current market shares of target merchandise and contending merchandise, an effective sales promotion and merchandise policy can be prepared.

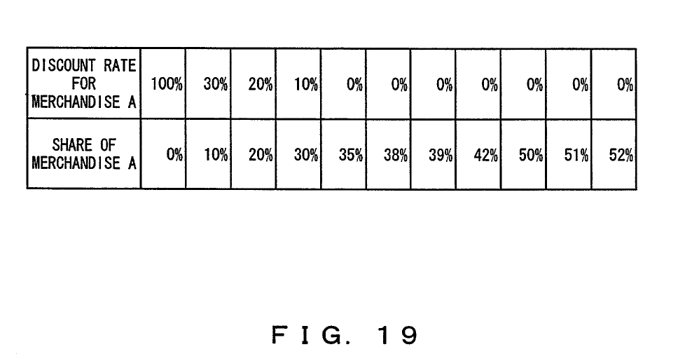

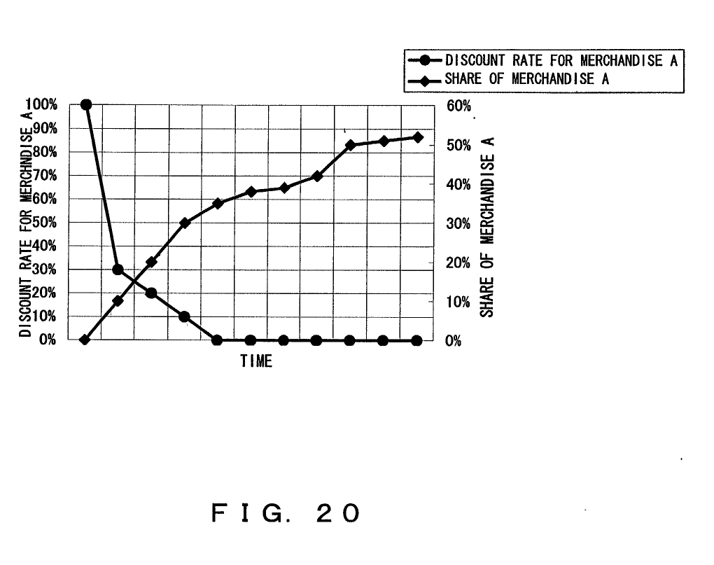

For example, when the discount rate changes as shown in FIG. 19 with the share fluctuation of the merchandise A, the changes of the share and the discount rate are represented in a time series by the graph as shown in FIG. 20. In FIG. 20, when the share of the merchandise A is 10%, the discount rate is 30%. With an increasing share of the merchandise A, the discount rate of the merchandise A decreases.

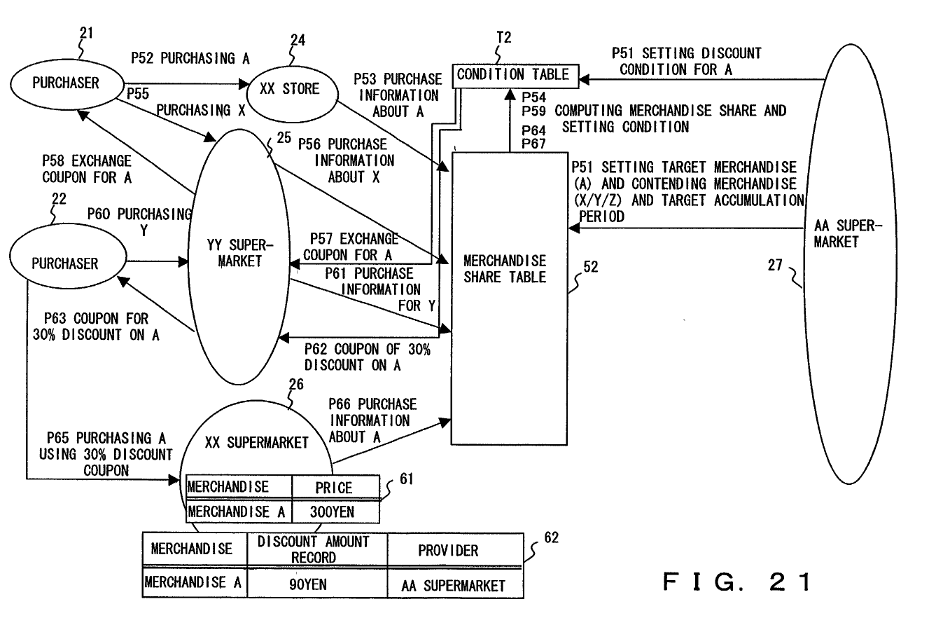

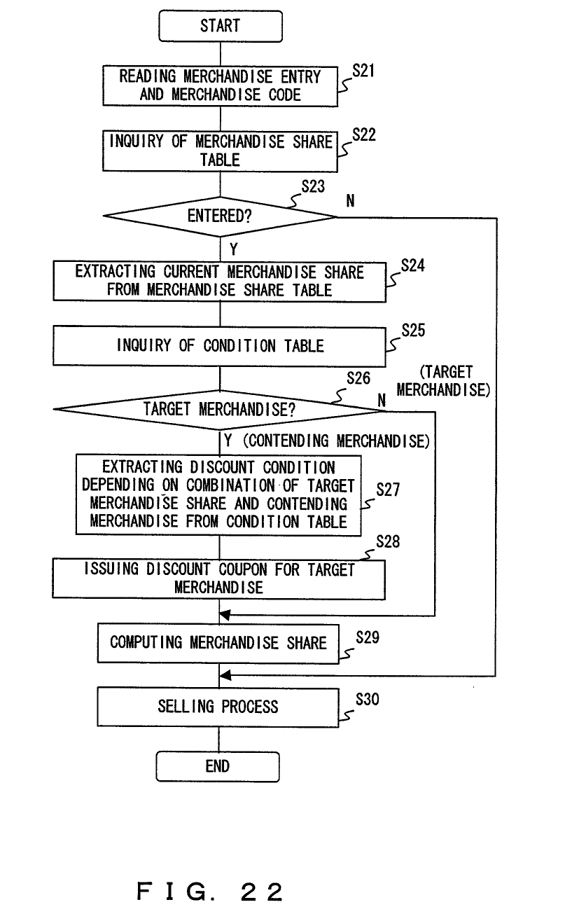

FIG. 21 shows the discounting process using the condition table T2 shown in FIG. 4, and FIG. 22 is a flowchart of the discounting process.

In this process, the AA supermarket 27 sets in the middleman's device in the network a plurality of discounting processes on the merchandise A depending on the combination of the share of the target merchandise A and the contending merchandise. When a purchaser purchases merchandise, a seller issues an inquiry to the middleman's device through a network. If purchased merchandise is contending merchandise against the merchandise A, then a merchandise A exchange coupon or a discount coupon is automatically issued to the purchaser depending on the current share of the merchandise A and the contending merchandise.

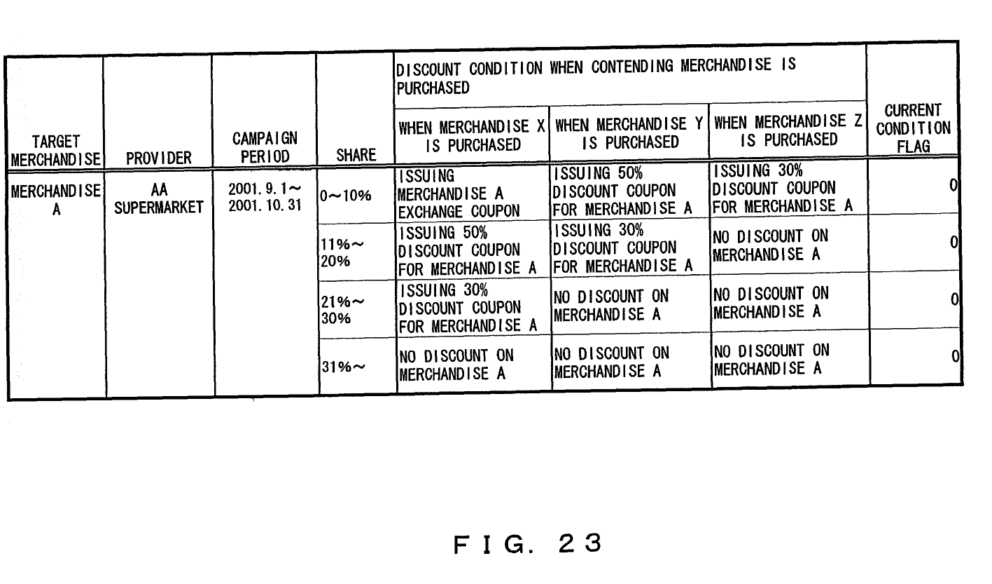

First, the AA supermarket 27 enters in the condition table T2 the discount condition depending on the combination of the share of the target merchandise A and the contending merchandise X, Y, and Z through the provider's device, and enters the merchandise A group and the target accumulation period in the merchandise share table 52 (P51, step S21). In this example, the information as shown in FIG. 23 is entered in the condition table T2, and the information as shown in FIG. 13 is entered in the merchandise share table 52.

When the purchaser 21 purchases the merchandise A from the XX store 24, the seller's device of the XX store 24 reads the merchandise code of the merchandise A (P52, step S21), and transmits the purchase information including the merchandise code to the middleman's device (P53). The middleman's device refers to the merchandise share table 52 according to the purchase information (step S22), and checks whether or not the merchandise A has been entered (step S23). As a result, it proves that the merchandise A has been entered in the merchandise A group.

The middleman's device refers to the condition table T2 (step S25), and checks whether or not the merchandise A is contending merchandise (step S26) As a result, it proves that the merchandise A is not contending merchandise, but the target merchandise.

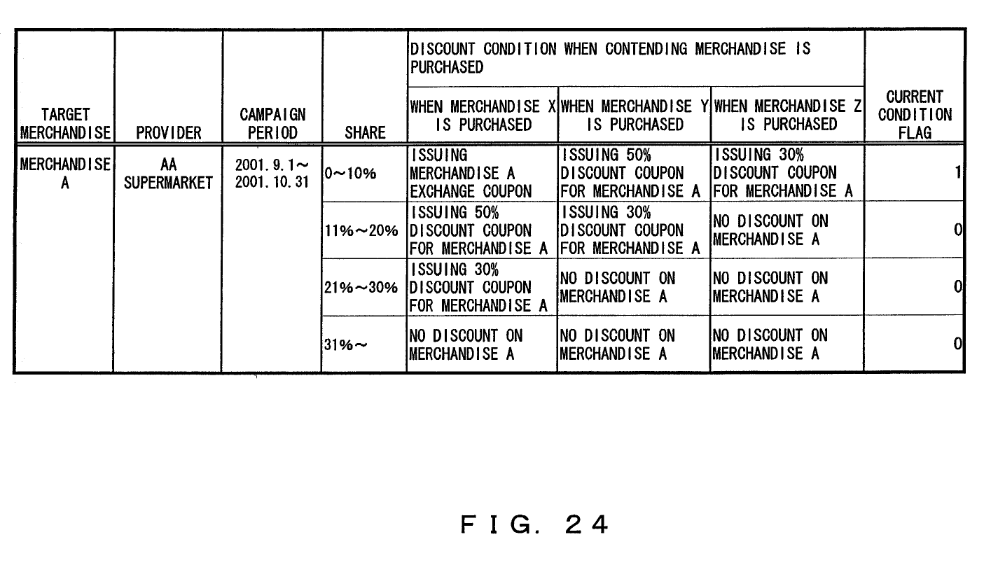

Therefore, the middleman's device computes the current sales volume and share of each article of merchandise, sets them in the merchandise share table 52, and sets a flag indicating the discount condition depending on the computed share in the condition table T2 (P54, step S29). As a result, the information about the merchandise A group of the merchandise share table 52 is changed as shown in FIG. 9, and the condition table T2 is changed as shown in FIG. 24. Then the seller's device of the XX store 24 performs a selling process on the merchandise A (step S30).

When the purchaser 21 purchases the merchandise X from the YY supermarket 25, the seller's device of the YY supermarket 25 reads the merchandise code of the merchandise X (P55, step S21), and transmits the purchase information to the middleman's device (P56). The middleman's device refers to the merchandise share table 52 (step S22), and checks whether or not the merchandise X has been entered (step S23). As a result, it proves that the merchandise X has been entered in the merchandise A group.

The middleman's device then refers to the condition table T2 (step S25), and checks whether or not the merchandise X is contending merchandise (step S26). As a result, it proves that the merchandise X is contending merchandise.

The middleman's device refers to the discount condition having the current condition flag set ON, determines the discounting process depending on the combination of the share of the merchandise A and the merchandise X, and notifies the YY supermarket 25 of the determination result (P57, step S27). In the condition table T2 shown in FIG. 24, the flags indicating the share of the merchandise A of 0˜10% are set ON. Therefore, the row is referred to. Then, ‘issuing merchandise A exchange coupon’ is obtained as a discounting process performed when the merchandise X is purchased, and the YY supermarket 25 is notified of the discounting process.

The seller's device of the YY supermarket 25 issues a merchandise A exchange coupon to the purchaser 21 (P58, step S28), and performs a selling process on the merchandise X (step S30).

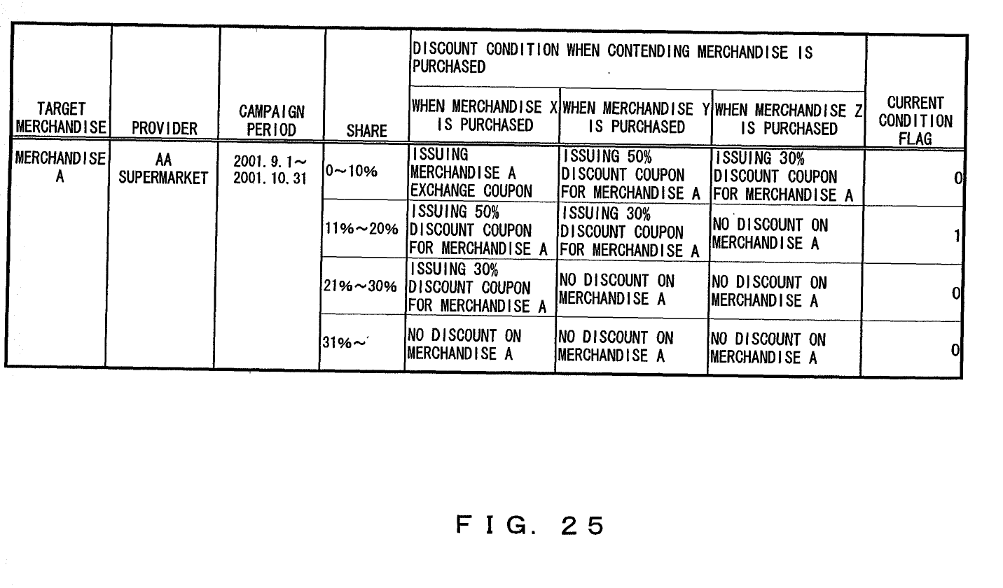

The middleman's device updates the merchandise share table 52 and the condition table T2 (P59, step S29). As a result, the merchandise share table 52 is changed as shown in FIG. 14, and the condition table T2 is changed as shown in FIG. 25.

In this example, instead of referring to the current condition flag of the condition table T2, the current share of the merchandise A is extracted from the merchandise share table 52 (step S24), and an inquiry can be issued to the condition table T2 (step S25).

When another purchaser 22 purchases the merchandise Y from the YY supermarket 25 (P60), the purchase information about the merchandise Y is transmitted from the seller's device of the YY supermarket 25 to the middleman's device (P61). The middleman's device refers to the merchandise share table 52 and the condition table T2, determines the discounting process, and notifies the YY supermarket 25 of the determination result (P62).

In the condition table T2 shown in FIG. 25, the flags indicating the share of 11˜20% of the merchandise A are set ON. Therefore, the row is referred to. Then, the YY supermarket 25 is notified of ‘issuing 30-percent discount coupon for merchandise A’ as the discounting process performed when the merchandise Y is purchased. The YY supermarket 25 issues to the purchaser 22 a 30-percent discount coupon for merchandise A (P63, step S28).

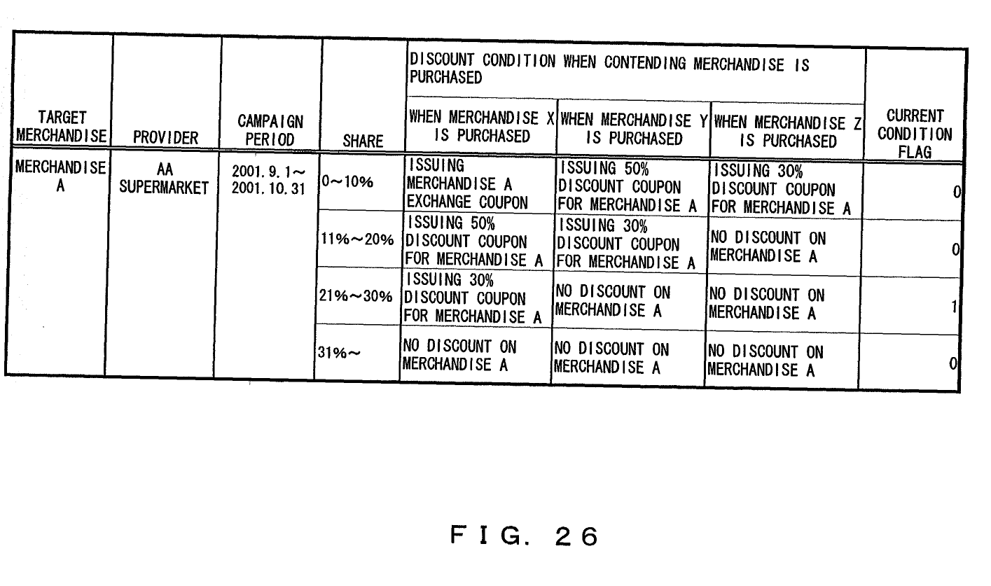

Then, the middleman's device updates the merchandise share table 52 and the condition table T2 (T64). As a result, the merchandise share table 52 is changed as shown in FIG. 16, and the condition table T2 is changed as shown in FIG. 26.

When the purchaser 22 purchases the merchandise A from the ZZ supermarket 26 using a 30-percent discount coupon for merchandise A (P65), the seller's device of the ZZ supermarket 26 computes the actual price (210 yen) of the merchandise A by subtracting the amount (90 yen) corresponding to a 30% discount from the price (300 yen) of the merchandise A of the price table 61. Then, the discount amount is entered in the discount record table 62, and the purchase information about the merchandise A is transmitted to the middleman's device (P66).

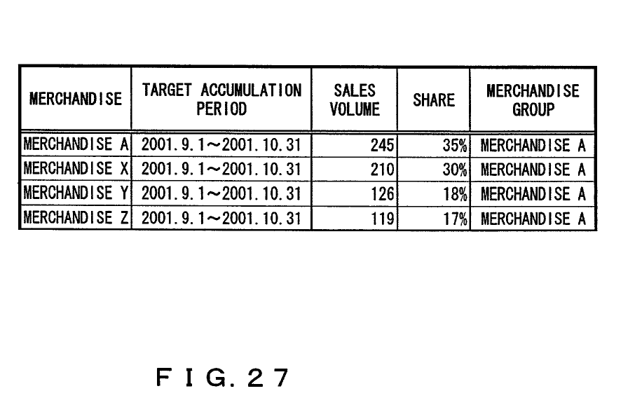

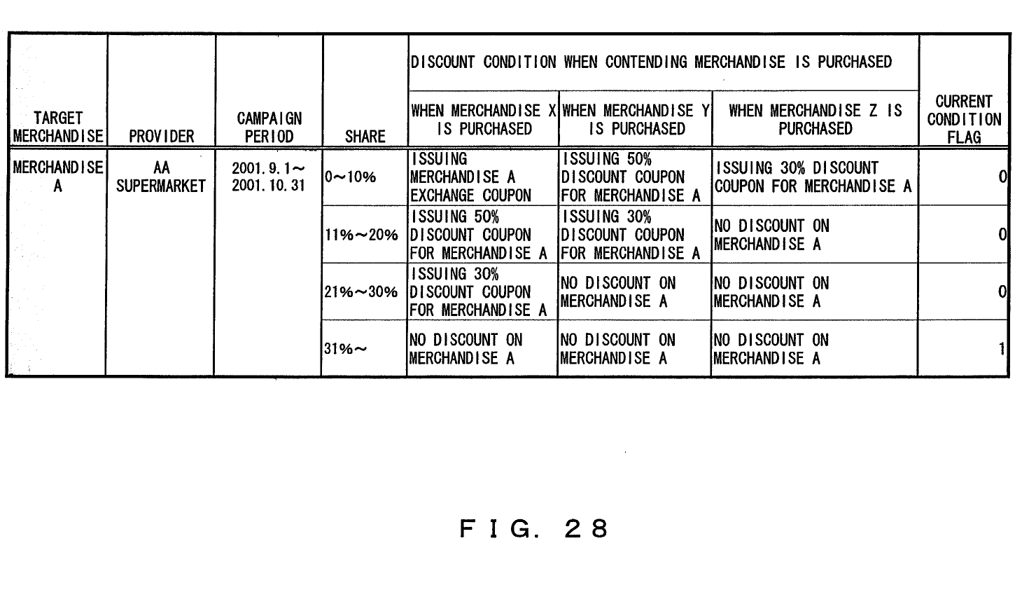

The middleman's device updates the merchandise share table 52 and the condition table T2 according to the received purchase information (P67). As a result, the merchandise share table 52 is changed as shown in FIG. 27, and the condition table T2 is changed as shown in FIG. 28.

In the above mentioned discounting process, a more strategic sales campaign can be carried out against specified contending merchandise.

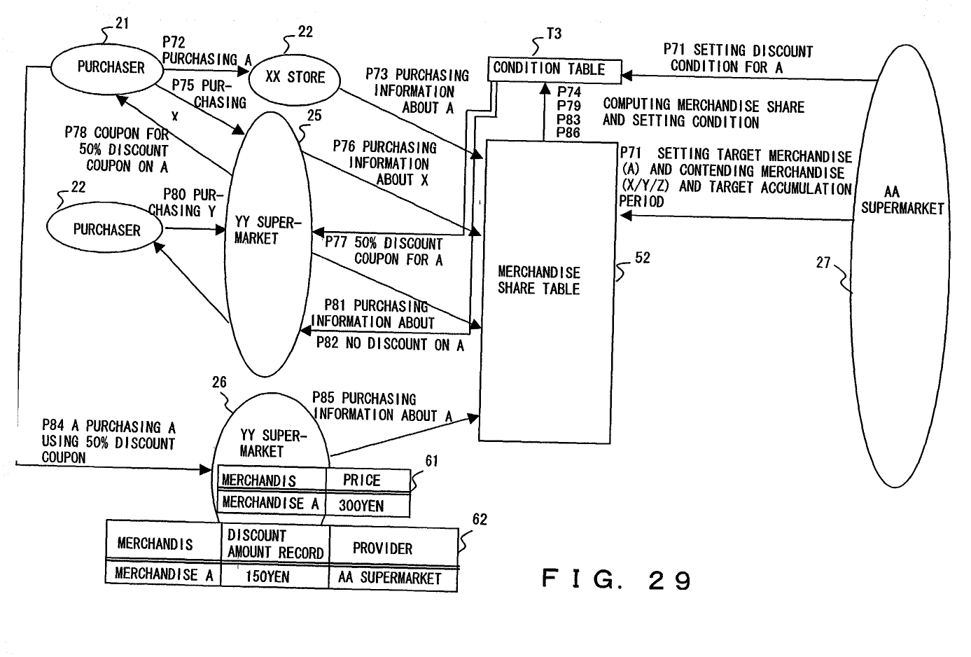

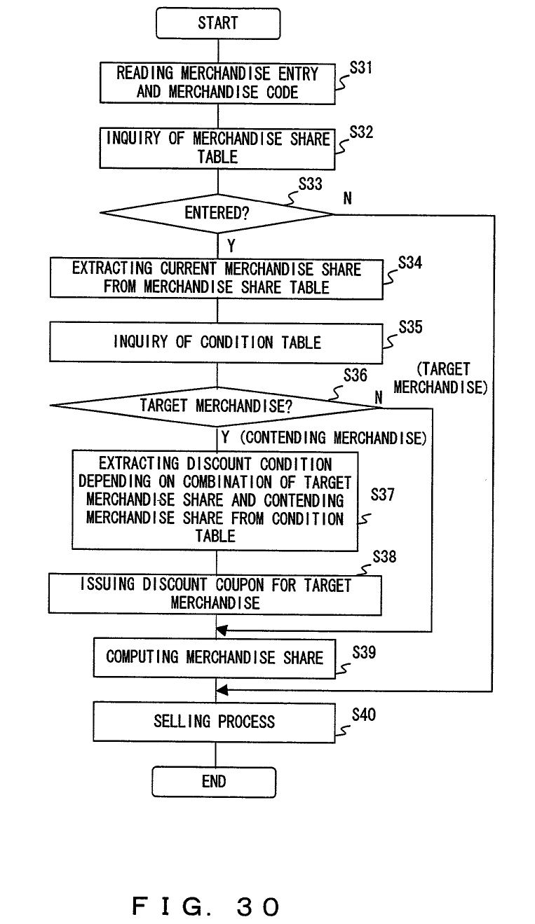

FIG. 29 shows the discounting process using the condition table T3 shown in FIG. 4, and FIG. 30 is a flowchart of the discounting process.

In this process, the AA supermarket 27 sets in the middleman's device in the network a plurality of discounting processes on the merchandise A depending on the combination of the share of the target merchandise A and the share of the contending merchandise. When a purchaser purchases merchandise, a seller issues an inquiry to the middleman's device through the network. If merchandise to be purchased is contending merchandise against the merchandise A, then a merchandise A exchange coupon or a discount coupon for merchandise A is automatically issued to the purchaser depending on the combination of the current share of the merchandise A and the current share of the contending merchandise.

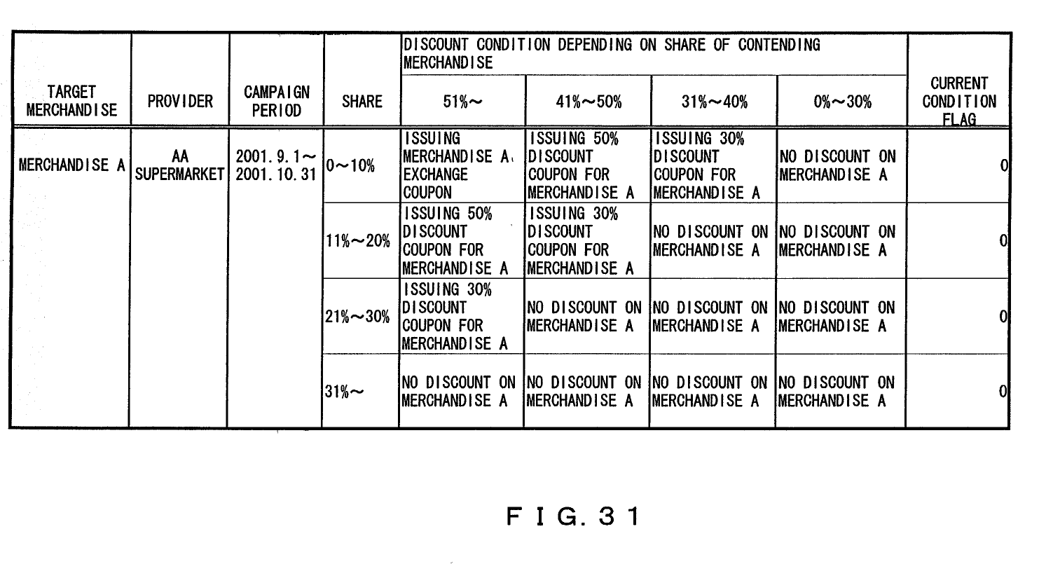

First, the AA supermarket 27 enters the discount condition in the condition table T3 through the provider's device depending on the combination of the share of the target merchandise A and the shares of the contending merchandise X, Y, and Z, and enters the merchandise A group and the target accumulation period in the merchandise share table 52 (P71, step S31). In this example, the information as shown in FIG. 31 is entered in the condition table T3, and the information as shown in FIG. 13 is entered in the merchandise share table 52.

When the purchaser 21 purchases the merchandise A from the XX store 24, the seller's device of the XX store 24 reads the merchandise code of the merchandise A (P72, step S31), and transmits the purchase information including the merchandise code to the middleman's device (P73). The middleman's device refers to the merchandise share table 52 according to the purchase information (step S32), and checks whether or not the merchandise A has been entered (step S33). As a result, it proves that the merchandise A has been entered in the merchandise A group.

Then, the middleman's device refers to the condition table T3 (step S35), and checks whether or not the merchandise A is contending merchandise (step S36) As a result, it proves that the merchandise A is not contending merchandise, but target merchandise.

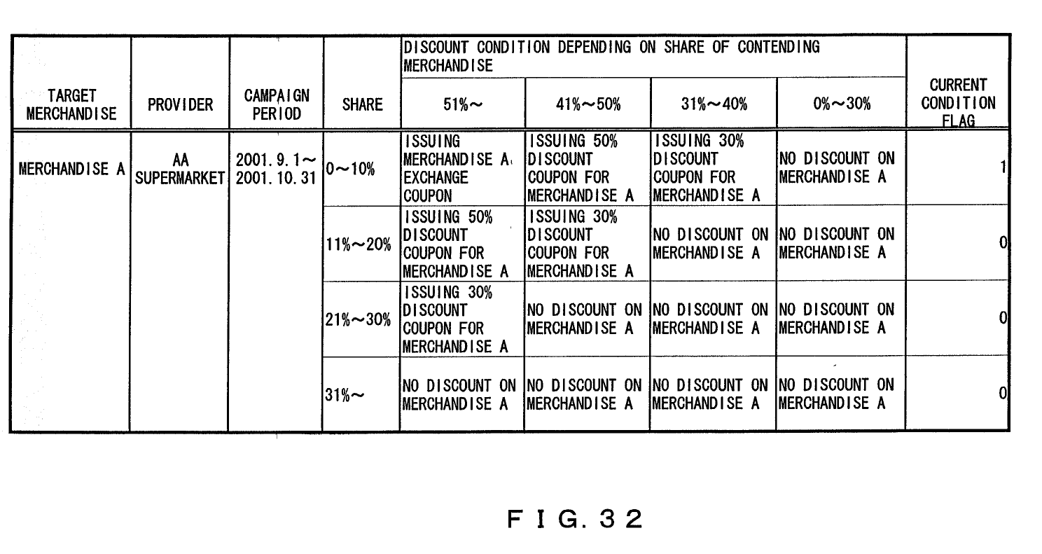

Then, the middleman's device computes the current sales volume and share of each article of merchandise, sets them in the merchandise share table 52, and sets a flag indicating the discount condition depending on the computed share in the condition table T2 (P74, step S39). As a result, the information about the merchandise A group of the merchandise share table 52 is changed as shown in FIG. 9, and the condition table T3 is changed as shown in FIG. 32. Then the seller's device of the XX store 24 performs a selling process on the merchandise A (step S40).

When the purchaser 21 purchases the merchandise X from the YY supermarket 25, the seller's device of the YY supermarket 25 reads the merchandise code of the merchandise X (P75, step S31), and transmits the purchase information to the middleman's device (P76). The middleman's device refers to the merchandise share table 52 (step S32), and checks whether or not the merchandise X has been entered (step S33). As a result, it proves that the merchandise X has been entered in the merchandise A group.

Then, the middleman's device then extracts the current share of the merchandise X from the merchandise share table 52 (step S34), refers to the condition table T3 (step S35), and checks whether or not the merchandise X is contending merchandise (step S36). As a result, it proves that the merchandise X is contending merchandise.

The middleman's device refers to the discount condition indicating the current condition flag set ON, determines the discounting process depending on the combination of the share of the merchandise A and the share of the merchandise X, and notifies the YY supermarket 25 of the determination result (P77, step S37).

In the condition table T3 shown in FIG. 32, since the flags indicating the share of 0˜10% of the merchandise A are set ON, the row is referred to. Additionally, since the share of the merchandise X is 45%, the column indicating the share of 41˜50% of the contending merchandise is referred to. As a result, as the discounting process performed when the merchandise X is purchased, ‘issuing a 50-percent discount coupon for merchandise A’ is obtained, and the YY supermarket 25 is notified of the discounting process.

The seller's device of the YY supermarket 25 issues a 50-percent discount coupon for merchandise A to the purchaser 21 (P78, step S38), and performs a selling process on the merchandise X (step S40).

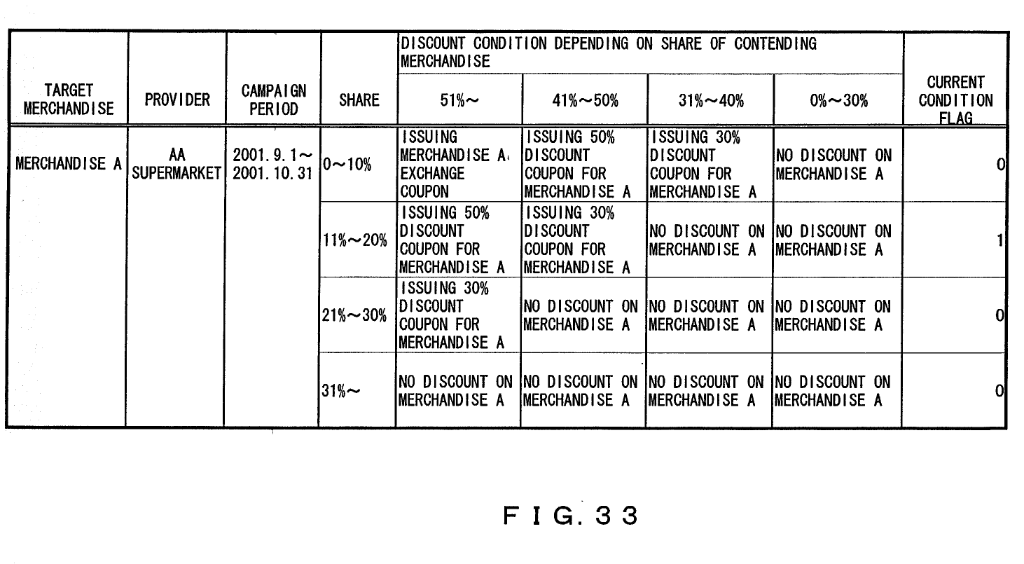

The middleman's device updates the merchandise share table 52 and the condition table T3 (P79, step S39). As a result, the merchandise share table 52 is changed as shown in FIG. 14, and the condition table T3 is changed as shown in FIG. 33.

In this example, instead of referring to the current condition flag of the condition table T3, the current shares of the merchandise A and X are extracted from the merchandise share table 52 (step S34), and an inquiry can be issued to the condition table T2 (step S35).

When another purchaser 22 purchases the merchandise Y from the YY supermarket 25 (P80), the purchase information about the merchandise Y is transmitted from the seller's device of the YY supermarket 25 to the middleman's device (P81). The middleman's device refers to the merchandise share table 52 and the condition table T3, determines the discounting process, and notifies the YY supermarket 25 of the determination result (P82).

In the condition table T3 shown in FIG. 33, the flags indicating the share of 11˜20% of the merchandise A are set ON. Therefore, the row is referred to. In the merchandise share table 52 shown in FIG. 14, the share of the merchandise Y is 29%. Therefore, the column indicating the share of 0˜30% of contending merchandise is referred to. As a result, the YY supermarket 25 is notified of ‘no discount for merchandise A’ as the discounting process performed when the merchandise Y is purchased. The YY supermarket 25 issues no coupon to the purchaser 22.

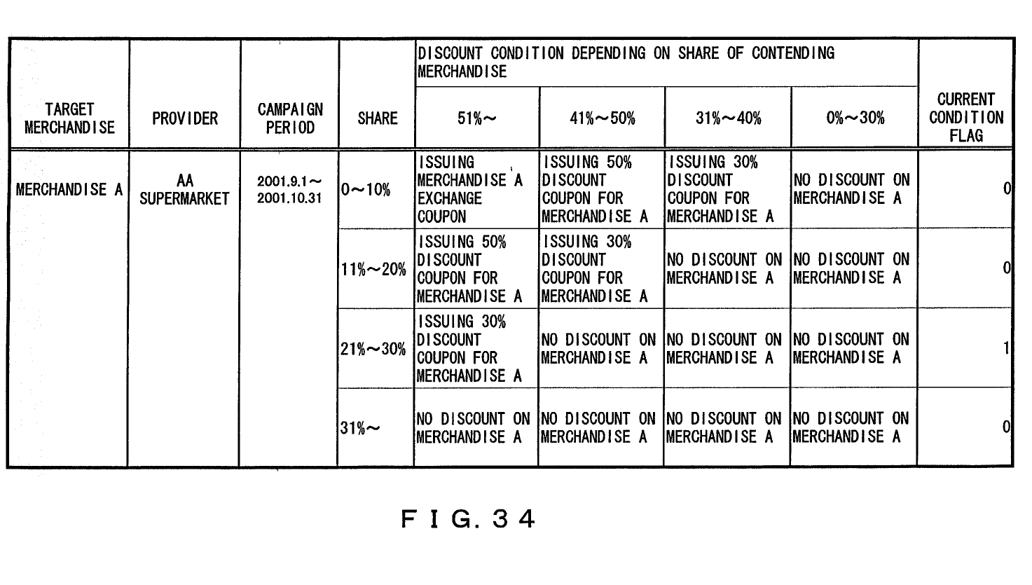

Then, the middleman's device updates the merchandise share table 52 and the condition table T3 (T83). As a result, the merchandise share table 52 is changed as shown in FIG. 16, and the condition table T3 is changed as shown in FIG. 34.

When the purchaser 21 purchases the merchandise A from the ZZ supermarket 26 using a 50-percent discount coupon for merchandise A (P84), the seller's device of the ZZ supermarket 26 computes the actual price (150 yen) of the merchandise A by subtracting the amount (150 yen) corresponding to a 50% discount from the price (300 yen) of the merchandise A of the price table 61. Then, the discount amount is entered in the discount record table 62, and the purchase information about the merchandise A is transmitted to the middleman's device (P85).

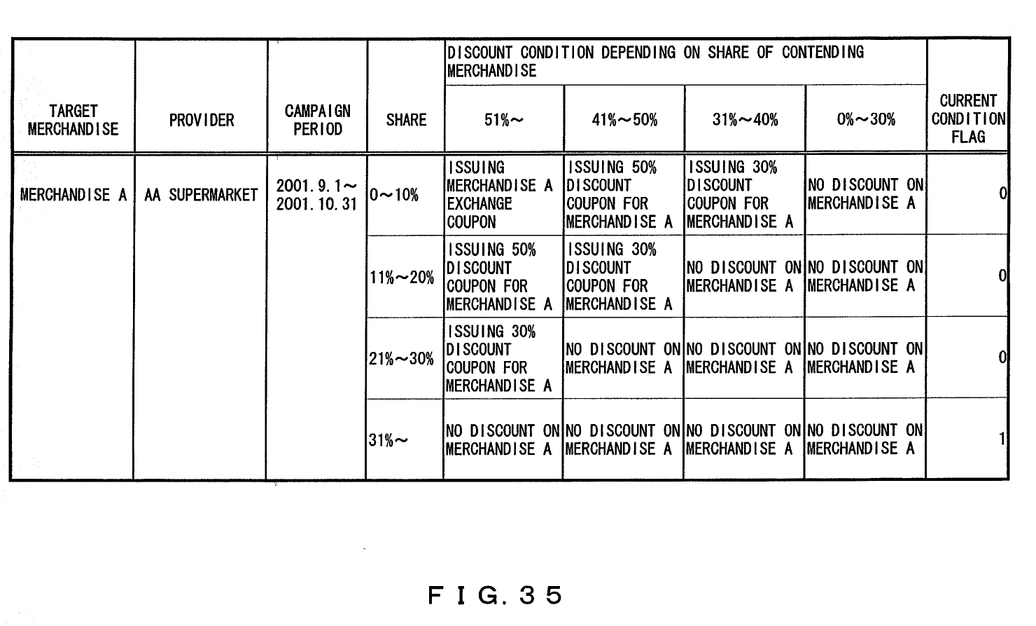

The middleman's device updates the merchandise share table 52 and the condition table T3 according to the received purchase information (P86). As a result, the merchandise share table 52 is changed as shown in FIG. 27, and the condition table T3 is changed as shown in FIG. 35.

In the above mentioned discounting process, a more aggressive sales campaign can be carried out to improve the share of target merchandise against contending merchandise having a high market share at each point in time.

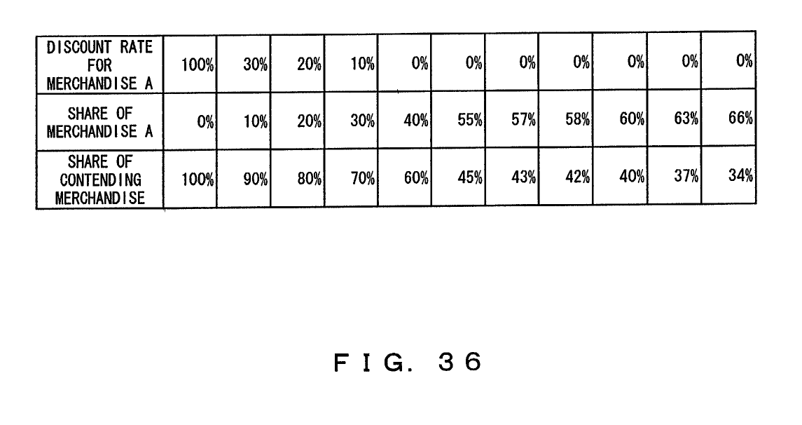

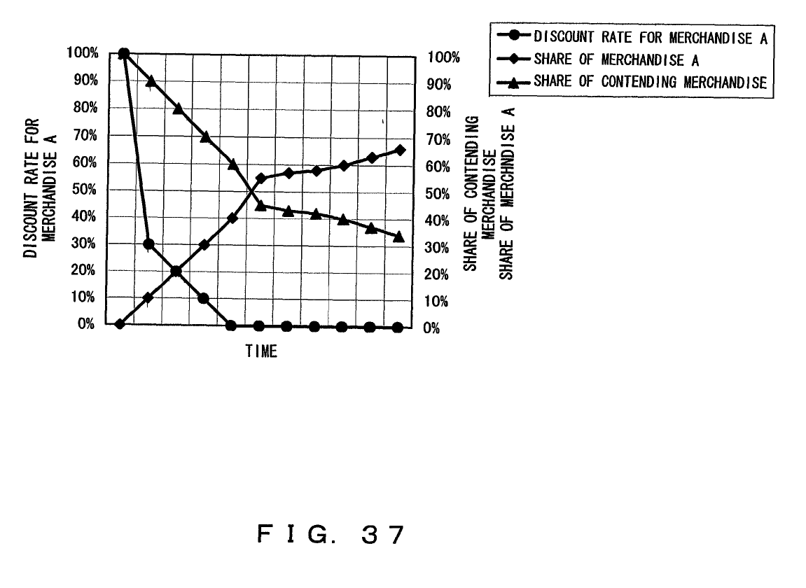

For example, when the discount rate of the merchandise A changes as shown in FIG. 36 with the share fluctuation of the merchandise A, the changes of the share and the discount rate are represented in a time series by the graph as shown in FIG. 37. In FIG. 37, when the share of the merchandise A is 20%, the share of the contending merchandise is 80%, and the discount rate is 20%. With an increasing share of the merchandise A (that is, with a decreasing share of the contending merchandise), the discount rate of the merchandise A decreases.

In the above mentioned embodiments, a provider provides merchandise. However, the provider can offer a service (for financial, insurance, traveling, facilities use, etc.) instead of merchandise with a discount in the above mentioned methods. In this case, instead of the identification information about target merchandise and contending merchandise, the identification information about a target service and a contending service are used, and a seller offers a service to a purchaser.

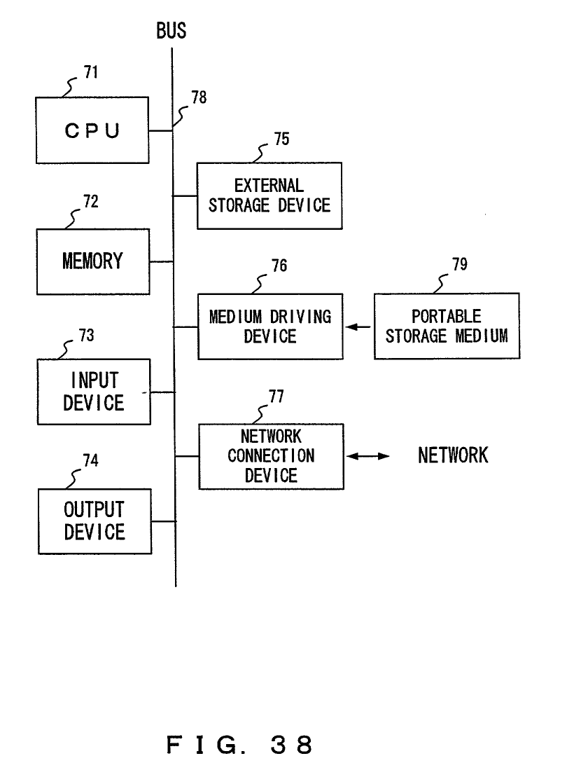

The seller's device 31, the middleman's device 32, and the provider's device 33 are configured using an information processing device (computer) as shown in FIG. 38. The information processing device shown in FIG. 38 comprises a CPU (central processing device) 71, memory 72, an input device 73, an output device 74, an external storage device 75, a medium driving device 76, and a network connection device 77. These components are interconnected through a bus 78.

The memory 72 can be, for example, ROM (read only memory), RAM (random access memory), etc., and stores a program and data for use in a process. The CPU 71 performs a necessary process by executing a program using the memory 72. The processing device 45 shown in FIG. 3 corresponds to the CPU 71 and the memory 72.

The input device 73 can be, for example, a keyboard, a pointing device, a touch panel, etc., and is used in inputting an instruction and information from an operator. The output device 74 can be, for example, a display, a printer, a speaker, etc., and is used in issuing an inquiry and a process result to an operator. The input device 47 shown in FIG. 3 corresponds to the input device 73 and the output device 74.

The external storage device 75 can be, for example, a magnetic disk device, an optical disk device, a magneto-optic disk device, a tape device, etc. An information processing device stores the above mentioned program and data in the external storage device 75, and uses them after loading them into the memory 72 as necessary. Additionally, the external storage device 75 can also be used as the database 46 shown in FIG. 3.

The medium driving device 76 drives a portable storage medium 79, and accesses the stored contents. The portable storage medium 79 can be any computer-readable storage medium such as a memory card, a flexible disk, CD-ROM (compact disk read only memory), an optical disk, a magneto-optic disk, etc. An operator stores the above mentioned program and data in the portable storage medium 79, and uses them after loading them into the memory 72 as necessary.

The network connection device 77 corresponds to the connection device 44 shown in FIG. 3, and converts data for communications. An information processing device receives the above mentioned program and data from other devices through the network connection device 77, and uses them after loading them into the memory 72 as necessary.

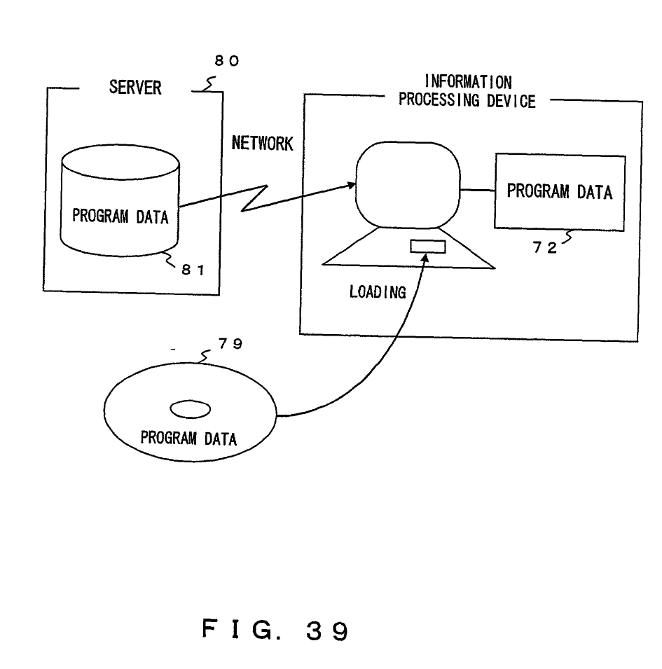

FIG. 39 shows a computer-readable storage medium capable of providing a program and data for the information processing device shown in FIG. 38. The program and data stored in the portable storage medium 79 and a database 81 of a server 80 is loaded into the memory 72. At this time, the server 80 generates a carrier signal for transmission of a program and data, and transmits the signal to the information processing device through any transmission medium in the network. The CPU 71 executes the program using the data and performs a necessary process.

According to the present invention, a provider can set a discount condition depending on the share of merchandise/service so that a discounting process can be automatically determined depending on the market share of the merchandise/service when it is purchased. Therefore, the market share of target merchandise/service can be efficiently improved by appropriately setting a discount condition. Furthermore, since the provider can be informed in real time of the share of target merchandise/service and contending merchandise/service, an effective merchandise/service can be designed and offered.

What is claimed is:

1. A method for discounting merchandise or service, comprising:
a computer referring to a condition table in which a discount condition is associated with a market share of the merchandise or service when a purchaser purchases the merchandise or service;
said computer determining discount information depending on a current share of the merchandise or service based on the condition table; and
said computer notifying a seller of the determined discount information.

2. The method according to claim 1, wherein
said computer notifies the seller of at least one, as the discount information, of information indicating sale of the merchandise or service at a discount and information indicating an issue of a coupon available when the merchandise or service is purchased.

3. A method for discounting merchandise or service, comprising:
a computer referring to a condition table in which a discount condition is associated with a combination of contending merchandise against target merchandise and a market share of the target merchandise or a combination of contending service against target service and a market share of the target service when a purchaser purchases the contending merchandise or the contending service;
said computer determining, based on the condition table, discount information about the target merchandise or the target service depending on a current share of the target merchandise or the target service; and
said computer notifying a seller of the determined discount information.

4. A method for discounting merchandise or service, comprising:
a computer referring to a condition table in which a discount condition is associated with a combination of a market share of target merchandise and a market share of contending merchandise against the target merchandise or a combination of a market share of target service and a market share of contending service against the target service when a purchaser purchases the contending merchandise or the contending service;
said computer determining, based on the condition table, discount information about the target merchandise or the target service depending on current shares of the target merchandise and the contending merchandise or current shares of the target service and the contending service; and
said computer notifying a seller of the determined discount information.

5. A method for discounting merchandise or service, comprising:
referring to a discount condition associated with a market share of the merchandise or service when a purchaser purchases the merchandise or service;
determining discount information depending on a current share of the merchandise or service based on the discount condition; and
notifying a seller of the determined discount information.

6. A method for discounting merchandise or service, comprising:
referring to a discount condition associated with a combination of contending merchandise against target merchandise and a market share of the target merchandise or a combination of contending service against target service and a market share of the target service when a purchaser purchases the contending merchandise or the contending service;
determining, based on the discount condition, discount information about the target merchandise or the target service depending on a current share of the target merchandise or the target service; and
notifying a seller of the determined discount information.

7. A method for discounting merchandise or service, comprising:
referring to a discount condition associated with a combination of a market share of target merchandise against the target merchandise and a market share of contending merchandise or a combination of a market share of target service and a market share of contending service against the target service when a purchaser purchases the contending merchandise or the contending service;
determining, based on the discount condition, discount information about the target merchandise or the target service depending on current shares of the target merchandise and the contending merchandise or current shares of the target service and the contending service; and
notifying a seller of the determined discount information.

8. An information processing device, comprising:
a reference unit referring to a condition table in which a discount condition is associated with a market share of the merchandise or service when a purchaser purchases the merchandise or service;
a determination unit determining discount information depending on a current share of the merchandise or service based on the condition table; and
a notification unit notifying a seller of the determined discount information.

9. An information processing device, comprising:
a reference unit referring to a condition table in which a discount condition is associated with a combination of contending merchandise against target merchandise and a market share of the target merchandise or a combination of contending service against target service and a market share of the target service when a purchaser purchases the contending merchandise or the contending service;
a determination unit determining, based on the condition table, discount information about the target merchandise or the target service depending on a current share of the target merchandise or the target service; and
a notification unit notifying a seller of the determined discount information.

10. An information processing device, comprising:
a reference unit referring to a condition table in which a discount condition is associated with a combination of a market share of target merchandise and a market share of contending merchandise against the target merchandise or a combination of a market share of target service and a market share of contending service against the target service when a purchaser purchases the contending merchandise or the contending service;
a determination unit determining, based on the condition table, discount information about the target merchandise or the target service depending on current shares of the target merchandise and the contending merchandise or current shares of the target service and the contending service; and
a notification unit notifying a seller of the determined discount information.

11. A computer-readable storage medium storing a program used to direct a computer to perform:
referring to a condition table in which a discount condition is associated with a market share of the merchandise or service when a purchaser purchases the merchandise or service;
determining discount information depending on a current share of the merchandise or service based on the condition table; and
notifying a seller of the determined discount information.

12. A computer-readable storage medium storing a program used to direct a computer to perform:
referring to a condition table in which a discount condition is associated with a combination of contending merchandise against target merchandise and a market share of the target merchandise or a combination of contending service against target service and a market share of the target service when a purchaser purchases the contending merchandise or the contending service;
determining, based on the condition table, discount information about the target merchandise or the target service depending on a current share of the target merchandise or the target service; and
notifying a seller of the determined discount information.

13. A computer-readable storage medium storing a program used to direct a computer to perform:
referring to a condition table in which a discount condition is associated with a combination of a market share of target merchandise and a market share of contending merchandise against the target merchandise or a combination of a market share of target service and a market share of contending service against the target service when a purchaser purchases the contending merchandise or the contending service;
determining, based on the condition table, discount information about the target merchandise or the target service depending on current shares of the target merchandise and the contending merchandise or current shares of the target service and the contending service; and
notifying a seller of the determined discount information.

14. A propagation signal propagating a program to a computer, said program directing the computer to perform:
referring to a condition table in which a discount condition is associated with a market share of the merchandise or service when a purchaser purchases the merchandise or service;
determining discount information depending on a current share of the merchandise or service based on the condition table; and
notifying a seller of the determined discount information.

15. A propagation signal propagating a program to a computer, said program directing the computer to perform:
referring to a condition table in which a discount condition is associated with a combination of contending merchandise against target merchandise and a market share of the target merchandise or a combination of contending service against target service and a market share of the target service when a purchaser purchases the contending merchandise or the contending service;
determining, based on the condition table, discount information about the target merchandise or the target service depending on a current share of the target merchandise or the target service; and
notifying a seller of the determined discount information.

16. A propagation signal propagating a program to a computer, said program directing the computer to perform:
referring to a condition table in which a discount condition is associated with a combination of a market share of target merchandise and a market share of contending merchandise against the target merchandise or a combination of a market share of target service and a market share of contending service against the target service when a purchaser purchases the contending merchandise or the contending service;
determining, based on the condition table, discount information about the target merchandise or the target service depending on current shares of the target merchandise and the contending merchandise or current shares of the target service and the contending service; and
notifying a seller of the determined discount information.
